(19) United States
(12) Patent Application Publication
(10) Pub. No.: US 2016/0065990 A1
(43) Pub. Date: Mar. 3, 2016

(54) IMAGE ENCODING METHOD, IMAGE DECODING METHOD, IMAGE ENCODING APPARATUS, IMAGE DECODING APPARATUS, IMAGE ENCODING PROGRAM, IMAGE DECODING PROGRAM, AND RECORDING MEDIA

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP); Hideaki KIMATA, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 14/783,301

(22) PCT Filed: Apr. 4, 2014
(86) PCT No.: PCT/JP2014/059963

§ 371 Date: Oct. 8, 2015

(30) Foreign Application Priority Data
Apr. 11, 2013 (JP) 2013-082957

(51) Int. Cl. H04N 19/597; H04N 19/172; H04N 19/176; H04N 19/44; H04N 13/00; H04N 19/553

(52) U.S. Cl. CPC H04N 19/597; H04N 13/0048; H04N 19/553; H04N 19/176; H04N 19/44; H04N 19/172

(57) ABSTRACT

An image encoding device and an image decoding device encodes with a low overall output size while preventing encoding-efficiency degradation in occlusion regions. When encoding a multiview image comprising a plurality of images from different perspectives, this device, using a reference image from a different perspective from a target image being encoded and a reference depth map for a subject in said reference image, encodes while performing image prediction across different perspectives. The device is provided with: a combined-perspective-image generation unit that uses the reference image and reference depth map to generate a combined-perspective image for the target image; a usability determination unit that, for each encoding region determines whether or not the combined-perspective image is usable; and an image encoding unit that performs predictive encoding on the target image while selecting predicted-image generation methods for encoding regions for which the combined-perspective image was determined to be unusable.

### TECHNICAL FIELD

The present invention relates to an image encoding method, an image decoding method, an image encoding apparatus, an image decoding apparatus, an image encoding program, an image decoding program, and recording media for encoding and decoding a multi-view image.

Priority is claimed on Japanese Patent Application No. 2013-082957, filed Apr. 11, 2013, the content of which is incorporated herein by reference.

### BACKGROUND ART

Conventionally, multi-view images each including a plurality of images obtained by photographing the same object and background using a plurality of cameras are known. A moving image captured by the plurality of cameras is referred to as a “multi-view moving image (multi-view video)”. In the following description, an image (moving image) captured by one camera is referred to as a “two-dimensional image (moving image)”, and a group of two-dimensional images (two-dimensional moving images) obtained by photographing the same object and background using a plurality of cameras differing in a position and/or direction (hereinafter referred to as a view) is referred to as a “multi-view image (multi-view moving image)”.

A two-dimensional moving image has a high correlation in relation to a time direction and coding efficiency can be improved using the correlation. On the other hand, when cameras are synchronized, frames (images) corresponding to the same time of videos of the cameras in a multi-view image or a multi-view moving image are frames (images) obtained by photographing the object and background in completely the same state from different positions, and thus there is a high correlation between the cameras (between different two-dimensional images of the same time). It is possible to improve coding efficiency using the correlation in coding of a multi-view image or a multi-view moving image.

Here, a conventional art relating to coding technology of two-dimensional moving images will be described. In many conventional two-dimensional moving-image coding schemes including H.264, MPEG-2, and MPEG-4, which are international coding standards, highly efficient encoding is performed using technologies of motion-compensated prediction, orthogonal transform, quantization, and entropy encoding. For example, in H.264, encoding using temporal correlations between an encoding target frame and a plurality of past or future frames is possible.

Details of the motion-compensated prediction technology used in H.264, for example, are disclosed in Non-Patent Document 1. An outline of the motion-compensated prediction technology used in H.264 will be described. The motion-compensated prediction of H.264 enables an encoding target frame to be divided into blocks of various sizes and enables the blocks to have different motion vectors and different reference frames. Using a different motion vector in each block, highly precise prediction which compensates for a different motion of a different object is realized. On the other hand, prediction having high precision considering occlusion caused by a temporal change is realized by using a different reference frame in each block.

Next, a conventional coding scheme for multi-view images or multi-view moving images will be described. A difference between the multi-view image coding scheme and the multi-view moving-image coding scheme is that a correlation in the time direction is simultaneously present in a multi-view moving image in addition to the correlation between the cameras. However, the same method using the correlation between the cameras can be used in both cases. Therefore, a method to be used in coding multi-view moving images will be described here.

In order to use the correlation between the cameras in the coding of multi-view moving images, there is a conventional scheme of encoding a multi-view moving image with high efficiency through “disparity-compensated prediction” in which motion-compensated prediction is applied to images captured by different cameras at the same time. Here, the disparity is a difference between positions at which the same portion on an object is present on image planes of cameras arranged at different positions. FIG. 27 is a conceptual diagram illustrating the disparity occurring between the cameras. In the conceptual diagram illustrated in FIG. 27, image planes of cameras having parallel optical axes face down vertically. In this manner, the positions at which the same portion on the object are projected on the image planes of the different cameras are generally referred to as corresponding points.

In the disparity-compensated prediction, each pixel value of an encoding target frame is predicted from a reference frame based on the corresponding relationship, and a prediction residual thereof and disparity information representing the corresponding relationship are encoded. Because the disparity varies for every pair of target cameras and positions of the target cameras, it is necessary to encode the disparity information for each region in which the disparity-compensated prediction is performed. Actually, in the multi-view moving-image coding scheme of H.264, a vector representing the disparity information is encoded for each block in which the disparity-compensated prediction is used.

The corresponding relationship provided by the disparity information can be represented by a one-dimensional amount representing a three-dimensional position of an object, rather than a two-dimensional vector, based on epipolar geometric constraints by using camera parameters. Although there are various representations as information representing the three-dimensional position of the object, the distance from a reference camera to the object or a coordinate value on an axis which is not parallel to an image plane of the camera is normally used. It is to be noted that the reciprocal of the distance may be used instead of the distance. In addition, because the reciprocal of the distance is information proportional to the disparity, two reference cameras may be set and a three-dimensional position may be represented as the amount of disparity between images captured by the cameras. Because there is no essential difference regardless of what expression is used, information representing a three-dimensional position is hereinafter expressed as a depth without such expressions being distinguished.

FIG. 28 is a conceptual diagram of epipolar geometric constraints. According to the epipolar geometric constraints, a point on an image of another camera corresponding to a point on an image of a certain camera is constrained to a straight line called an epipolar line. At this time, if a depth for the pixel is obtained, a corresponding point is uniquely determined on the epipolar line. For example, as illustrated in FIG. 28, a corresponding point in an image of a second camera for an object projected at a position m in an image of a first camera is projected at a position m′ on the epipolar line when the position of the object in a real space is M′ and it is projected at a position m″ on the epipolar line when the position of the object in the real space is M″.

A highly precise prediction is realized and efficient multi-view moving-image coding is realized by generating a synthesized image for an encoding target frame from a reference frame in accordance with three-dimensional information of each object given by a depth map (distance image) for the reference frame using this property and designating the generated synthesized image as a predicted image. It is to be noted that the synthesized image generated based on the depth is referred to as a view-synthesized image, a view-interpolated image, or a disparity-compensated image.

However, because the reference frame and the encoding target frame are images captured by cameras located at different positions, due to an influence of framing and/or occlusion, there is a region in which an object and background which are present in the encoding target frame but are not present in the reference frame are shown. Thus, in such a region, the view-synthesized image cannot provide an appropriate predicted image. Hereinafter, the region in which the view-synthesized image cannot provide the appropriate predicted image is referred to as an occlusion region.

Non-Patent Document 2 realizes efficient coding using a spatial or temporal correlation even in an occlusion region by performing further prediction on a difference image between the encoding target image and the view-synthesized image. In addition, in Non-Patent Document 3, it is possible to realize efficient coding by designating a generated view-synthesized image as a candidate for a predicted image in each region and using a predicted image predicted by another method for an occlusion region.

### PRIOR ART DOCUMENTS

### Non-Patent Documents

Non-Patent Document 1: ITU-T Recommendation H.264 (March 2009), “Advanced video coding for generic audiovisual services”, March 2009.
Non-Patent Document 2: Shinya SHIMIZU, Masaki KITAHARA, Kazuto KAMIKURA, and Yoshiyuki YASHIMA, “Multi-view Video Coding based on 3-D Warping with Depth Map”, In Proceedings of Picture Coding Symposium 2006, SS3-6, April, 2006.
Non-Patent Document 3: S. Shimizu, H. Kimata, and Y. Ohtani, “Adaptive appearance compensated view synthesis prediction for Multiview Video Coding”, Image Processing (ICIP), 2009 16th IEEE International Conference on Image Processing, pp. 2949-2952, 7-10 Nov. 2009.

### SUMMARY OF INVENTION

### Problems to be Solved by the Invention

With the methods of Non-Patent Document 2 and 3, it is possible to realize highly efficient prediction as a whole by combining inter-camera prediction based on a view-synthesized image obtained by performing highly precise disparity compensation using three-dimensional information of an object obtained from a depth map with spatial or temporal prediction in the occlusion region.

However, in the method disclosed in Non-Patent Document 2, there is a problem in that an unnecessary bit amount is generated because information indicating a method for performing prediction on a difference image between the encoding target image and the view-synthesized image must be encoded even for a region in which highly precise prediction is provided by the view-synthesized image.

On the other hand, in the method disclosed in Non-Patent Document 3, it is not required to encode unnecessary information because it is only necessary to indicate that prediction using the view-synthesized image is performed for a region in which highly precise prediction can be provided by the view-synthesized image. However, there is a problem in that the number of candidates for the predicted image increases because the view-synthesized image is included in the candidates for the predicted image regardless of whether highly precise prediction is provided. That is, there is a problem in that not only does the computational complexity necessary for selecting a predicted image generation method increase, but also a large bit amount is necessary to indicate the predicted image generation method.

The present invention has been made in view of such circumstances, and an object thereof is to provide an image encoding method, an image decoding method, an image encoding apparatus, an image decoding apparatus, an image encoding program, an image decoding program, and recording media recording the programs capable of realizing coding in a small bit amount as a whole while preventing code efficiency in an occlusion region from being degraded when a multi-view moving image is encoded or decoded using a view-synthesized image as one of predicted images.

### Means for Solving the Problems

An aspect of the present invention is an image encoding apparatus which performs encoding while predicting an image between different views using a reference image encoded for a view different from that of an encoding target image and a reference depth map for an object in the reference image when a multi-view image including images of a plurality of different views is encoded, the image encoding apparatus comprising: a view-synthesized image generating unit which generates a view-synthesized image for the encoding target image using the reference image and the reference depth map; an availability determining unit which determines whether the view-synthesized image is available for each of encoding target regions into which the encoding target image is divided; and an image encoding unit which performs predictive encoding on the encoding target image while selecting a predicted image generation method if the availability determining unit determines that the view-synthesized image is unavailable for each of the encoding target regions.

Preferably, for each of the encoding target regions, the image encoding unit encodes a difference between the encoding target image and the view-synthesized image for each of the encoding target regions if the availability determining unit determines that the view-synthesized image is available and performs the predictive encoding on the encoding target image while selecting the predicted image generation method if the availability determining unit determines that the view-synthesized image is unavailable.

Preferably, for each of the encoding target regions, the image encoding unit generates encoding information if the availability determining unit determines that the view-synthesized image is available.

Preferably, the image encoding unit determines a prediction block size as the encoding information.

Preferably, the image encoding unit determines a prediction method and generates encoding information for the prediction method.

Preferably, the availability determining unit determines whether the view-synthesized image is available based on quality of the view-synthesized image in each of the encoding target regions.

Preferably, the image encoding apparatus further comprises an occlusion map generating unit which generates an occlusion map representing pixels occluded on the reference image among pixels on the encoding target image using the reference depth map, wherein the availability determining unit determines whether the view-synthesized image is available based on the number of the occluded pixels present within each of the encoding target regions using the occlusion map.

An aspect of the present invention is an image decoding apparatus which performs decoding while predicting an image between different views using a reference image decoded for a view different from that of a decoding target image and a reference depth map for an object in the reference image when the decoding target image is decoded from encoded data of a multi-view image including images of a plurality of different views, the image decoding apparatus comprising: a view-synthesized image generating unit which generates a view-synthesized image for the decoding target image using the reference image and the reference depth map; an availability determining unit which determines whether the view-synthesized image is available for each of decoding target regions into which the decoding target image is divided; and an image decoding unit which decodes the decoding target image from the encoded data while generating a predicted image if the availability determining unit determines that the view-synthesized image is unavailable for each of the decoding target regions.

Preferably, for each of the decoding target regions, the image decoding unit generates the decoding target image while decoding a difference between the decoding target image and the view-synthesized image from the encoded data if the availability determining unit determines that the view-synthesized image is available, and decodes the decoding target image from the encoded data while generating the predicted image if the availability determining unit determines that the view-synthesized image is unavailable.

Preferably, for each of the decoding target regions, the image decoding unit generates encoding information if the availability determining unit determines that the view-synthesized image is available.

Preferably, the image decoding unit determines a prediction block size as the encoding information.

Preferably, the image decoding unit determines a prediction method and generates encoding information for the prediction method.

Preferably, the availability determining unit determines whether the view-synthesized image is available based on quality of the view-synthesized image in each of the decoding target regions.

Preferably, the image decoding apparatus further comprises an occlusion map generating unit which generates an occlusion map representing pixels occluded on the reference image among pixels on the decoding target image using the reference depth map, wherein the availability determining unit determines whether the view-synthesized image is available based on the number of the occluded pixels present within each of the decoding target regions using the occlusion map.

An aspect of the present invention is an image encoding method for performing encoding while predicting an image between different views using a reference image encoded for a view different from that of an encoding target image and a reference depth map for an object in the reference image when a multi-view image including images of a plurality of different views is encoded, the image encoding method comprising: a view-synthesized image generating step of generating a view-synthesized image for the encoding target image using the reference image and the reference depth map; an availability determining step of determining whether the view-synthesized image is available for each of encoding target regions into which the encoding target image is divided; and an image encoding step of performing predictive encoding on the encoding target image while selecting a predicted image generation method if it is determined that the view-synthesized image is unavailable in the availability determining step for each of the encoding target regions.

An aspect of the present invention is an image decoding method for performing decoding while predicting an image between different views using a reference image decoded for a view different from that of a decoding target image and a reference depth map for an object in the reference image when the decoding target image is decoded from encoded data of a multi-view image including images of a plurality of different views, the image decoding method comprising: a view-synthesized image generating step of generating a view-synthesized image for the decoding target image using the reference image and the reference depth map; an availability determining step of determining whether the view-synthesized image is available for each of decoding target regions into which the decoding target image is divided; and an image decoding step of decoding the decoding target image from the encoded data while generating a predicted image if it is determined that the view-synthesized image is unavailable in the availability determining step for each of the decoding target regions.

An aspect of the present invention is an image encoding program for causing a computer to execute the image encoding method.

An aspect of the present invention is an image decoding program for causing a computer to execute the image decoding method.

### Advantageous Effects of the Invention

With the present invention, there is an advantage in that it is possible to code a multi-view image and a multi-view moving image in a small bit amount as a whole while preventing coding efficiency in an occlusion region from being degraded by adaptively performing switching between encoding in which only a view-synthesized image is used as a predicted image and encoding in which an image other than the view-synthesized image is used as the predicted image on a region-by-region basis based on quality of the view-synthesized image such as presence/absence of the occlusion region when the view-synthesized image is used as one of predicted images.

### BRIEF DESCRIPTION OF DRAWINGS

FIG. 1 is a block diagram illustrating a configuration of an image encoding apparatus in an embodiment of the present invention.

FIG. 2 is a flowchart illustrating an operation of the image encoding apparatus 100a illustrated in FIG. 1.

FIG. 3 is a block diagram illustrating an example of a configuration of the image encoding apparatus when an occlusion map is generated and used.

FIG. 4 is a flowchart illustrating a processing operation in which the image encoding apparatus generates a decode image.

FIG. 5 is a flowchart illustrating a processing operation in which a difference signal between an encoding target image and a view-synthesized image is encoded for a region in which the view-synthesized image is available.

FIG. 6 is a flowchart illustrating a modified example of the processing operation illustrated in FIG. 5.

FIG. 7 is a block diagram illustrating a configuration of an image encoding apparatus when encoding information is generated for a region for which it is determined that a view-synthesized image is available so that the encoding information can be referred to when another region or another frame is encoded.

FIG. 8 is a flowchart illustrating a processing operation of the image encoding apparatus 100c illustrated in FIG. 7.

FIG. 9 is a flowchart illustrating a modified example of the processing operation illustrated in FIG. 8.

FIG. 10 is a block diagram illustrating a configuration of an image encoding apparatus when the number of regions in which view synthesis is possible is obtained and encoded.

FIG. 11 is a flowchart illustrating a processing operation when the image encoding apparatus 100d illustrated in FIG. 10 encodes the number of regions in which view synthesis is possible.

FIG. 12 is a flowchart illustrating a modified example of the processing operation illustrated in FIG. 11.

FIG. 13 is a block diagram illustrating a configuration of an image decoding apparatus in an embodiment of the present invention.

FIG. 14 is a flowchart illustrating an operation of the image decoding apparatus 200a illustrated in FIG. 13.

FIG. 15 is a block diagram illustrating a configuration of an image decoding apparatus when an occlusion map is generated and used to determine whether the view-synthesized image is available.

FIG. 16 is a flowchart illustrating a processing operation when the image decoding apparatus 200b illustrated in FIG. 15 generates a view-synthesized image for each region.

FIG. 17 is a flowchart illustrating a processing operation when a difference signal between a decoding target image and a view-synthesized image is decoded from a bitstream for a region in which the view-synthesized image is available.

FIG. 18 is a block diagram illustrating a configuration of an image decoding apparatus when encoding information is generated for a region for which it is determined that a view-synthesized image is available so that the encoding information can be referred to when another region or another frame is decoded.

FIG. 19 is a flowchart illustrating a processing operation of the image decoding apparatus 200c illustrated in FIG. 18.

FIG. 20 is a flowchart illustrating a processing operation when a difference signal between a decoding target image and a view-synthesized image is decoded from a bitstream and the decoding target image is generated.

FIG. 21 is a block diagram illustrating a configuration of an image decoding apparatus in which the number of regions in which view synthesis is possible is decoded from a bitstream.

FIG. 22 is a flowchart illustrating a processing operation when the number of regions in which view synthesis is possible is decoded.

FIG. 23 is a flowchart illustrating a processing operation of performing decoding while counting the number of decoded regions for which it is determined that the view-synthesized image is unavailable.

FIG. 24 is a flowchart illustrating a processing operation of performing a process while counting the number of decoded regions for which it is determined that the view-synthesized image is available.

FIG. 25 is a block diagram illustrating a hardware configuration when the image encoding apparatuses 100a to 100d are constituted of a computer and a software program.

FIG. 26 is a block diagram illustrating a hardware configuration when the image decoding apparatuses 200a to 200d are constituted of a computer and a software program.

FIG. 27 is a conceptual diagram of disparity which occurs between cameras.

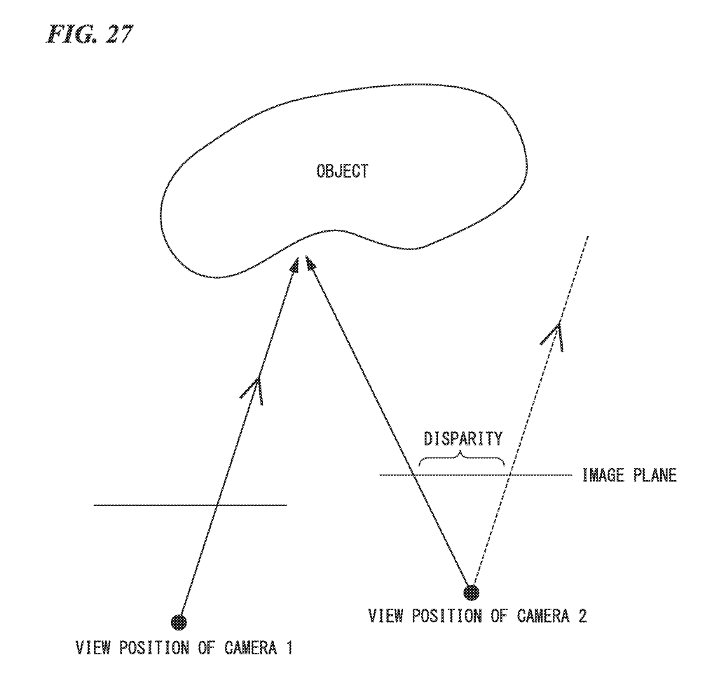

FIG. 28 is a conceptual diagram of epipolar geometric constraints.

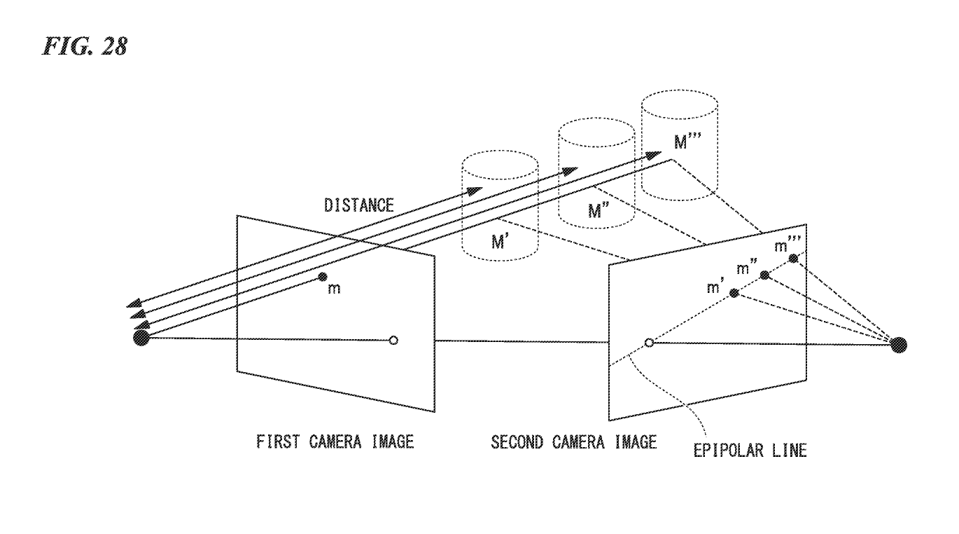

### MODES FOR CARRYING OUT THE INVENTION

Hereinafter, image encoding apparatuses and image decoding apparatuses in accordance with embodiments of the present invention will be described with reference to the drawings.

In the following description, the case in which a multi-view image captured by two cameras including a first camera (referred to as a camera A) and a second camera (referred to as a camera B) is encoded is assumed and an image of the camera B is encoded or decoded by using an image of the camera A as a reference image.

It is to be noted that information necessary for obtaining a disparity from depth information is assumed to be separately given. Specifically, this information includes extrinsic parameters representing a positional relationship of the cameras A and B and/or intrinsic parameters representing projection information for image planes by the cameras; however, other information in other forms may be given as long as the disparity is obtained from the depth information. A detailed description relating to these camera parameters, for example, is disclosed in a document <Olivier Faugeras, “Three-Dimensional Computer Vision”, pp. 33-66, MIT Press; BCTC/UFF-006.37 F259 1993, ISBN: 0-262-06158-9>. This document provides a description relating to parameters representing a positional relationship of a plurality of cameras and parameters representing projection information for an image plane by a camera.

In the following description, information (a coordinate value or an index that can be associated with the coordinate value) capable of specifying a position that is interposed between symbols [ ] is added to an image, a video frame, or a depth map to represent an image signal sampled by a pixel of the position or a depth therefor. In addition, by adding an index value that can be associated with a coordinate value or a block to a vector, a coordinate value or a block of a position obtained by shifting the coordinate value or the block by an amount of the vector is represented.

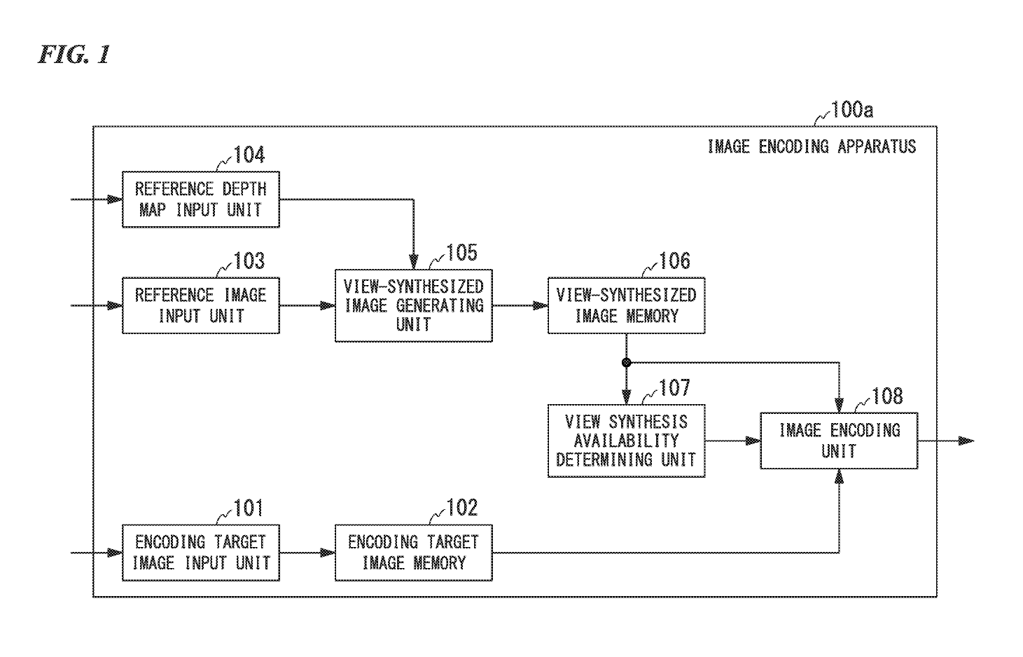

FIG. 1 is a block diagram illustrating a configuration of an image encoding apparatus in the present embodiment. As illustrated in FIG. 1, the image encoding apparatus 100a includes an encoding target image input unit 101, an encoding target image memory 102, a reference image input unit 103, a reference depth map input unit 104, a view-synthesized image generating unit 105, a view-synthesized image memory 106, a view synthesis availability determining unit 107, and an image encoding unit 108.

The encoding target image input unit 101 inputs an image serving as an encoding target. Hereinafter, the image serving as the encoding target is referred to as an encoding target image. Here, an image of the camera B is assumed to be input. In addition, a camera (here, the camera B) capturing the encoding target image is referred to as an encoding target camera. The encoding target image memory 102 stores the input encoding target image. The reference image input unit 103 inputs an image which is referred to when a view-synthesized image (disparity-compensated image) is generated. Hereinafter, the image input here is referred to as a reference image. Here, an image of the camera A is assumed to be input.

The reference depth map input unit 104 inputs a depth map which is referred to when the view-synthesized image is generated. Here, a depth map for the reference image is assumed to be input, but a depth map for another camera is also acceptable. Hereinafter, this depth map is referred to as a reference depth map. It is to be noted that the depth map indicates a three-dimensional position of an object shown in each pixel of the corresponding image. As long as the three-dimensional position is obtained using information such as separately given camera parameters, any information may be used as the depth map. For example, it is possible to use the distance from a camera to an object, a coordinate value for an axis which is not parallel to an image plane, or a disparity amount for another camera (for example, the camera B). In addition, because it is only necessary to obtain a disparity amount here, a disparity map directly representing the disparity amount, rather than the depth map, may be used. It is to be noted that although the depth map is given in the form of an image here, the depth map may not be in the form of an image as long as similar information can be obtained. Hereinafter, a camera (here, the camera A) corresponding to the reference depth map is referred to as a reference depth camera.

The view-synthesized image generating unit 105 obtains a corresponding relationship between a pixel of the encoding target image and a pixel of the reference image using the reference depth map and generates a view-synthesized image for the encoding target image. The view-synthesized image memory 106 stores the generated view-synthesized image for the encoding target image. The view synthesis availability determining unit 107 determines whether a view-synthesized image for each of regions into which the encoding target image is divided is available. The image encoding unit 108 performs predictive encoding on the encoding target image for each of the regions into which the encoding target image is divided based on the determination of the view synthesis availability determining unit 107.

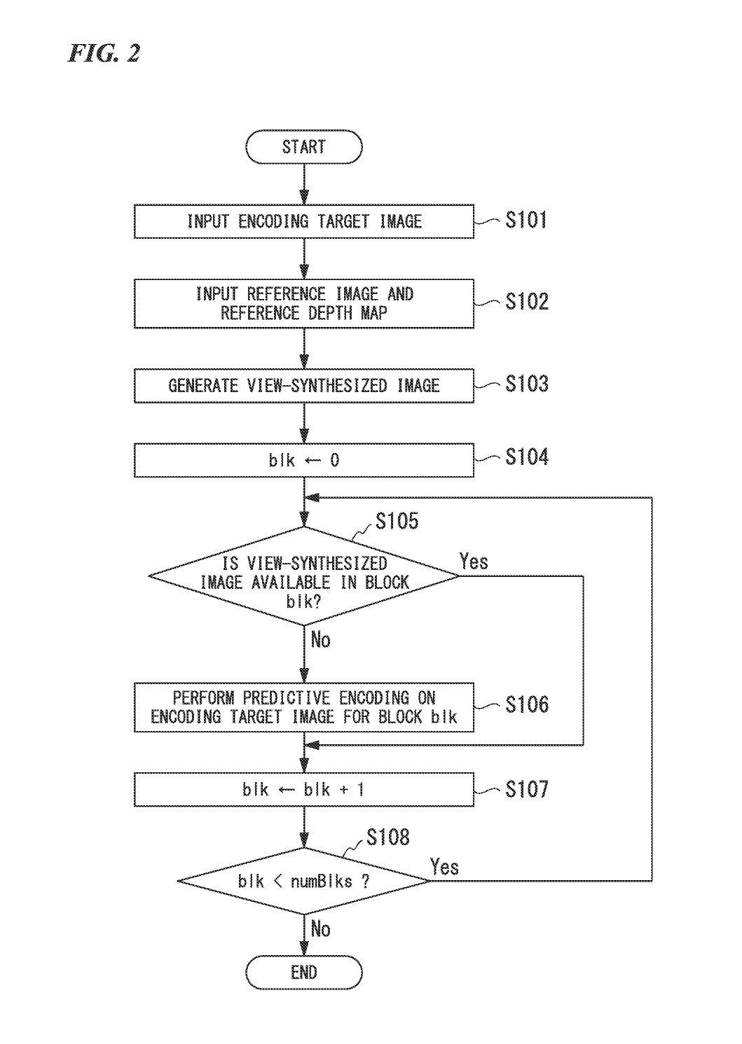

Next, an operation of the image encoding apparatus 100a illustrated in FIG. 1 will be described with reference to FIG. 2. FIG. 2 is a flowchart illustrating the operation of the image encoding apparatus 100a illustrated in FIG. 1. First, the encoding target image input unit 101 inputs an encoding target image Org and stores the input encoding target image Org in the encoding target image memory 102 (step S101). Next, the reference image input unit 103 inputs a reference image and outputs the input reference image to the view-synthesized image generating unit 105, and the reference depth map input unit 104 inputs a reference depth map and outputs the input reference depth map to the view-synthesized image generating unit 105 (step S102).

It is to be noted that the reference image and the reference depth map input in step S102 are assumed to be the same as those to be obtained by the decoding end, such as those obtained by decoding an already encoded reference image and reference depth map. This is because the occurrence of coding noise such as a drift is suppressed by using exactly the same information as that obtained by an image decoding apparatus. However, when this occurrence of coding noise is allowed, a reference image and a depth map obtained by only an encoding end, such as a reference image and a depth map before encoding, may be input. In relation to the reference depth map, for example, a depth map estimated by applying stereo matching or the like to a multi-view image decoded for a plurality of cameras, a depth map estimated using a decoded disparity vector or motion vector or the like can be used as a depth map to be equally obtained by the decoding end, in addition to a depth map obtained by performing decoding on an already encoded depth map.

Next, the view-synthesized image generating unit 105 generates a view-synthesized image Synth for the encoding target image and stores the generated view-synthesized image Synth in the view-synthesized image memory 106 (step S103). The process here may use any method as long as it is a method for synthesizing an image in the encoding target camera using the reference image and the reference depth map. For example, a method disclosed in Non-Patent Document 2 or a document “Y. Mori, N. Fukushima, T. Fujii, and M. Tanimoto, ‘View Generation with 3D Warping Using Depth Information for FTV’, In Proceedings of 3DTV-CON2008, pp. 229-232, May 2008”, may be used.

Next, when the view-synthesized image is obtained, predictive encoding is performed on the encoding target image while the availability of the view-synthesized image is determined for each of the regions into which the encoding target image is divided. That is, after a variable blk indicating an index of each of the regions into which the encoding target image is divided is initialized to zero, wherein each of the regions is a unit for which an encoding process is performed (step 104), the following process (steps S105 and S106) is iterated until blk reaches the number of regions numBlks within the encoding target image (step S108) while blk is incremented by 1 (step S107).

In the process to be performed for each of the regions into which the encoding target image is divided, the view synthesis availability determining unit 107 first determines whether the view-synthesized image is available for the region blk (step S105), and predictive encoding is performed on the encoding target image for the block blk in accordance with a determination result (step S106). The process of determining whether the view-synthesized image is available to be performed in step S105 will be described below.

If it is determined that the view-synthesized image is available, an encoding process of the region blk ends. In contrast, if it is determined that the view-synthesized image is unavailable, the image encoding unit 108 performs predictive encoding on the encoding target image of the region blk and generates a bitstream (step S106). As long as decoding can be correctly performed on the decoding end, any method may be used in the predictive encoding. It is to be noted that the generated bitstream becomes part of an output of the image encoding apparatus 100a.

In general moving-image coding and image coding such as MPEG-2, H.264, or JPEG, encoding for each region is performed by selecting one mode from among a plurality of prediction modes, generating a predicted image, performing frequency transform such as a discrete cosine transform (DCT) on a difference signal between the encoding target image and the predicted image, and sequentially applying processes of quantization, binarization, and entropy encoding on a resultant value. It is to be noted that although a view-synthesized image may be used as one of candidates for the predicted image in encoding, it is possible to reduce a bit amount required for mode information by excluding the view-synthesized image from the candidates for the predicted image. As a method for excluding the view-synthesized image from the candidates for the predicted image, a method for deleting an entry for the view-synthesized image from a table for identifying the prediction mode or a method using a table in which there is no entry for the view-synthesized image may be used.

Here, the image encoding apparatus 100a outputs a bitstream for an image signal. That is, a header and a parameter set indicating information such as the size of an image are assumed to be separately added to the bitstream output by the image encoding apparatus 100a, if necessary.

Any method may be used in the process of determining whether the view-synthesized image is available to be performed in step S105 as long as the same determination method is available on the decoding end. For example, availability may be determined in accordance with quality of the view-synthesized image for the region blk, that is, it may be determined that the view-synthesized image is available if the quality of the view-synthesized image is greater than or equal to a separately defined threshold value and it may be determined that the view-synthesized image is unavailable if the quality of the view-synthesized image is less than the threshold value. However, because the encoding target image for the region blk is unavailable on the decoding end, it is necessary to evaluate the quality using the view-synthesized image or a result obtained by encoding and decoding the encoding target image in an adjacent region. As a method for evaluating the quality using only the view-synthesized image, it is possible to use the no-reference (NR) image quality metric. In addition, an error amount between the result obtained by encoding and decoding the encoding target image in the adjacent region and the view-synthesized image may be used as an evaluation value.

As another method, there is a method for making a determination in accordance with presence/absence of an occlusion region in the region blk. That is, it may be determined that the view-synthesized image is unavailable if the number of pixels of the occlusion region in the region blk is greater than or equal to a separately defined threshold value and it may be determined that the view-synthesized image is available if the number of pixels of the occlusion region in the region blk is less than the threshold value. In particular, the threshold value may be set as 1 and it may be determined that the view-synthesized image is unavailable if even one pixel is included in the occlusion region.

It is to be noted that in order to correctly obtain the occlusion region, it is necessary to perform view synthesis while appropriately determining a front-to-back relationship of objects when the view-synthesized image is generated. That is, it is necessary to prevent a synthesized image from being generated for a pixel occluded by another object on the reference image among pixels of the encoding target image. When the synthesized image is prevented from being generated, it is possible to determine whether there is an occlusion region using the view-synthesized image by initializing a pixel value of each pixel of the view-synthesized image to a value which cannot be taken before the view-synthesized image is generated. In addition, when the view-synthesized image is generated, an occlusion map indicating the occlusion region may be simultaneously generated and a determination may be made using the occlusion map.

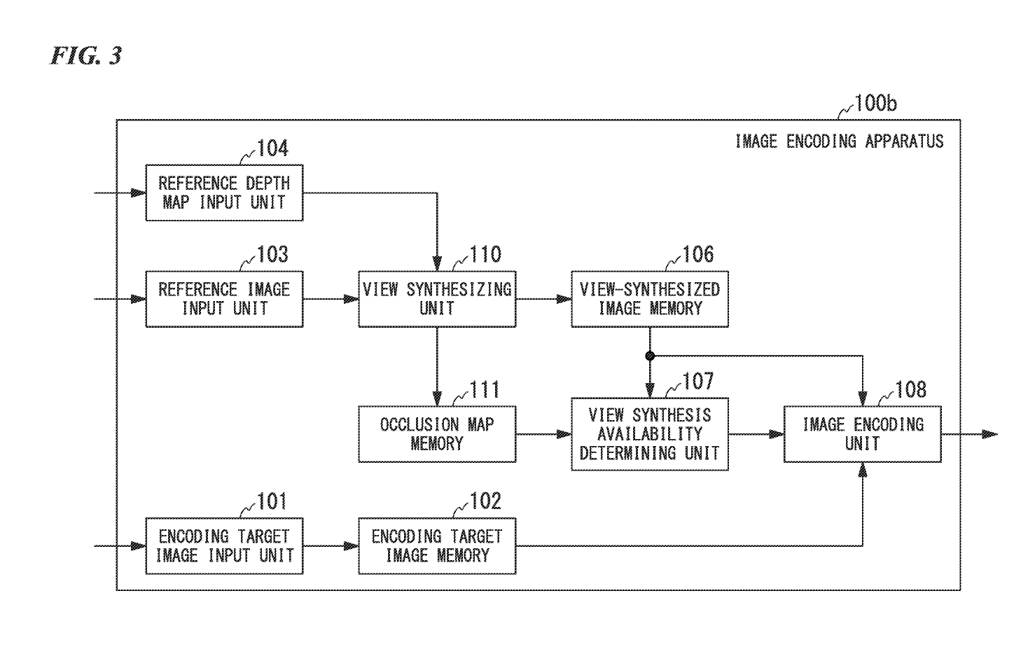

Next, a modified example of the image encoding apparatus illustrated in FIG. 1 will be described with reference to FIG. 3. FIG. 3 is a block diagram illustrating an example of a configuration of the image encoding apparatus when an occlusion map is generated and used. The image encoding apparatus 100b illustrated in FIG. 3 is different from the image encoding apparatus 100a illustrated in FIG. 1 in that a view synthesizing unit 110 and an occlusion map memory 111 are provided in place of the view-synthesized image generating unit 105. It is to be noted that the same components as those of the image encoding apparatus 100a illustrated in FIG. 1 are assigned the same reference signs and a description thereof will be omitted.

The view synthesizing unit 110 obtains a corresponding relationship between a pixel of the encoding target image and a pixel of the reference image using a reference depth map and generates a view-synthesized image and an occlusion map for the encoding target image. Here, the occlusion map represents whether it is possible to map an object shown in each pixel of the encoding target image onto the reference image. The occlusion map memory 111 stores the generated occlusion map.

Any method may be used for generation of the occlusion map as long as it is possible to perform the same process on the decoding end. For example, the occlusion map may be obtained by analyzing a view-synthesized image generated by initializing a pixel value of each pixel to a value which cannot be taken as described above, or the occlusion map may be generated by initializing the occlusion map so as to designate that all pixels are occlusions and every time a view-synthesized image is generated for a pixel overwriting a value for the pixel with a value indicating that the pixel is not an occlusion region. In addition, there is also a method for generating the occlusion map by estimating an occlusion region through analysis of the reference depth map. For example, there is a method for extracting an edge from the reference depth map and estimating the range of the occlusion from the strength and orientation of the edge.

As one of methods for generating a view-synthesized image, there is a technique of generating a certain pixel value by performing spatio-temporal prediction on an occlusion region. This process is referred to as inpainting. In this case, a pixel of which pixel value is generated by the inpainting may be used as an occlusion region or it may not be used as an occlusion region. It is to be noted that when the pixel of which pixel value is generated by the inpainting is handled as the occlusion region, it is necessary to generate the occlusion map because it is impossible to use the view-synthesized image for a determination of the occlusion.

As still another method, a determination based on quality of the view-synthesized image and a determination based on whether there is an occlusion region may be combined. For example, there is a method for combining the two determinations and determining that the view-synthesized image is unavailable if criteria are not satisfied in the two determinations. In addition, there is also a method for changing a threshold value of the quality of the view-synthesized image in accordance with the number of pixels included in the occlusion region. Further, there is also a method for making a determination based on the quality only if the criterion is not satisfied in the determination of whether there is an occlusion region.

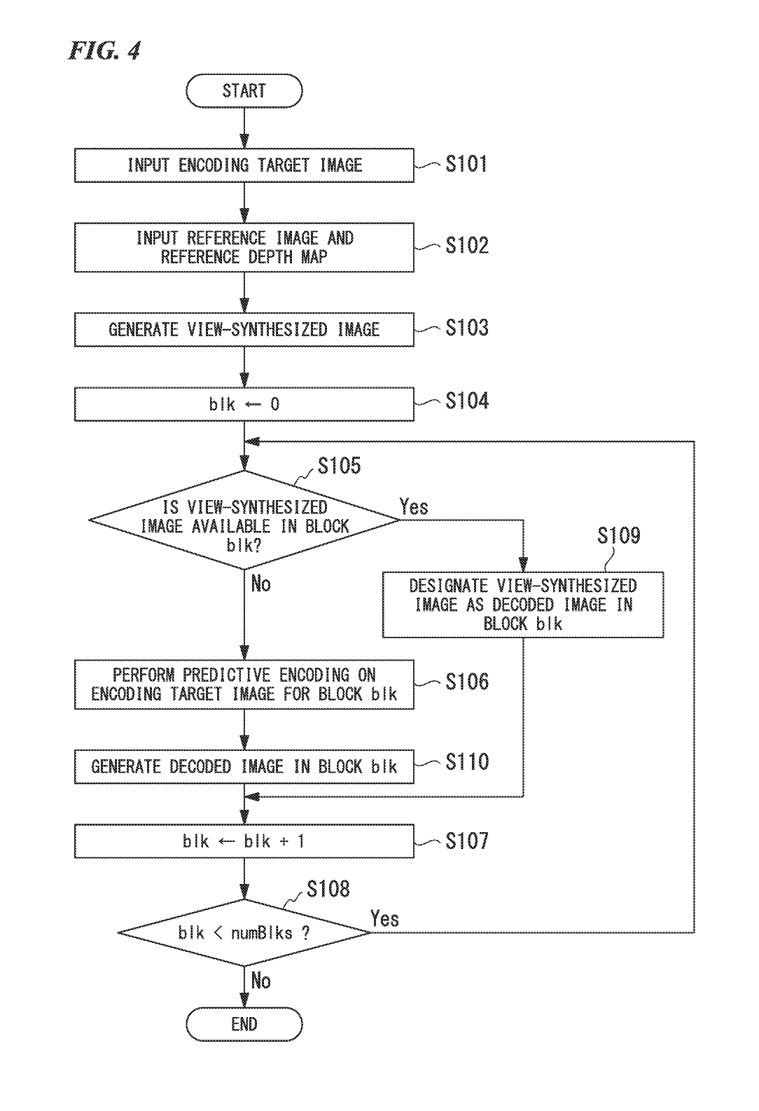

Although a decoded image for the encoding target image is not generated in the above description, the decoded image is generated when the decoded image for the encoding target image is used for encoding of another region or another frame. FIG. 4 is a flowchart illustrating a processing operation in which the image encoding apparatus generates the decoded image. The processing operations of FIG. 4 that are the same as those illustrated in FIG. 2 are assigned the same reference signs and a description thereof will be omitted. The processing operation illustrated in FIG. 4 is different from that illustrated in FIG. 2 in that it is determined whether a view-synthesized image is available (step S105) and a process of designating the view-synthesized image as a decoded image if it is determined that the view-synthesized image is available (step S109) and a process of generating a decoded image if the view-synthesized image is unavailable (step S110) are added.

It is to be noted that the process of generating the decoded image to be performed in step S110 may be performed in any method as long as the same decoded image as that of the decoding end can be obtained. For example, the process may be performed by performing decoding on a bitstream generated in step S106 or it may be performed in a simplified manner by performing inverse quantization and inverse transform on a value obtained by lossless encoding using binarization and entropy encoding and adding a resultant value to a predicted image.

In addition, although no bitstream is generated for a region in which the view-synthesized image is available in the above description, a difference signal between the encoding target image and the view-synthesized image may be encoded. It is to be noted that the difference signal may be expressed as a simple difference or it may be expressed as a remainder of the encoding target image as long as it is possible to correct an error of the view-synthesized image for the encoding target image. However, it is necessary for the decoding end to determine a method with which the difference signal is expressed. For example, a certain expression may be always used or information indicating an expression method may be encoded and signaled for each frame. A different expression method may be used for a different pixel or frame by determining an expression method using information which is also obtained on the decoding end such as a view-synthesized image, a reference depth map, or an occlusion map.

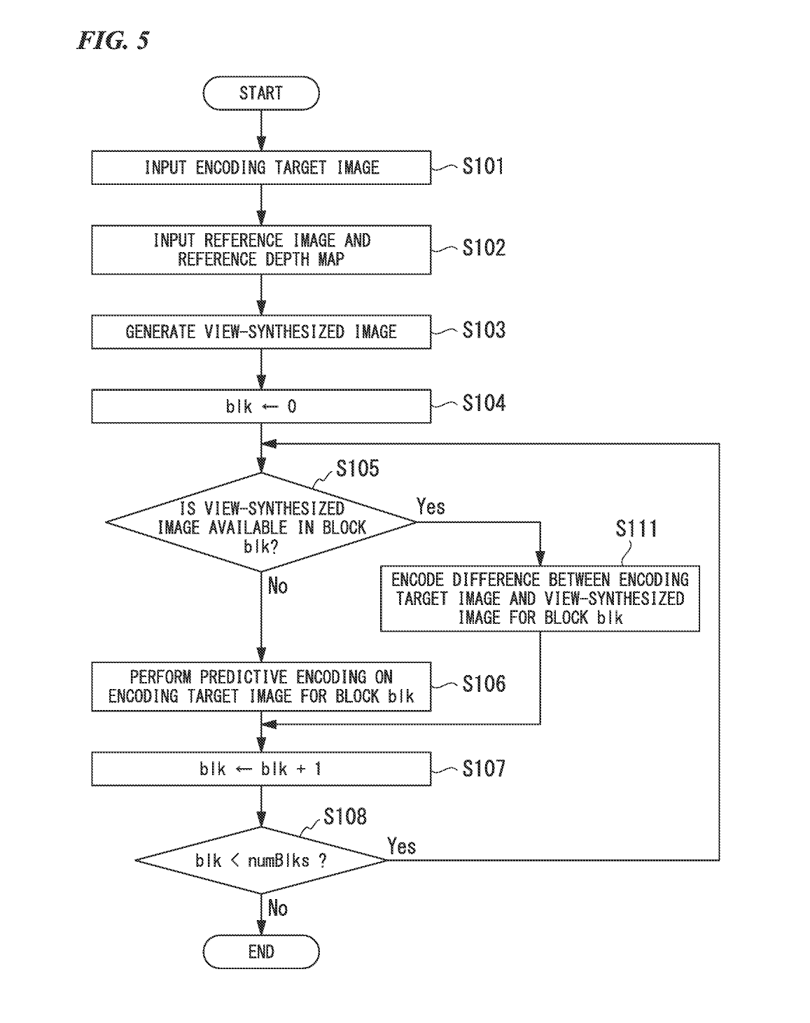

FIG. 5 is a flowchart illustrating a processing operation in which a difference signal between an encoding target image and a view-synthesized image is encoded for a region in which the view-synthesized image is available. The processing operation illustrated in FIG. 5 is different from that illustrated in FIG. 2 in that step S111 is added and the rest is the same. The steps of performing the same processes are assigned the same reference signs and a description thereof will be omitted.

In the processing operation illustrated in FIG. 5, the difference signal between the encoding target image and the view-synthesized image is encoded and a bitstream is generated if it is determined that the view-synthesized image is available for a region blk (step S111). As long as the difference signal can be correctly decoded on the decoding end, any method may be used in encoding of the difference signal. The generated bitstream becomes part of an output of the image encoding apparatus 100a.

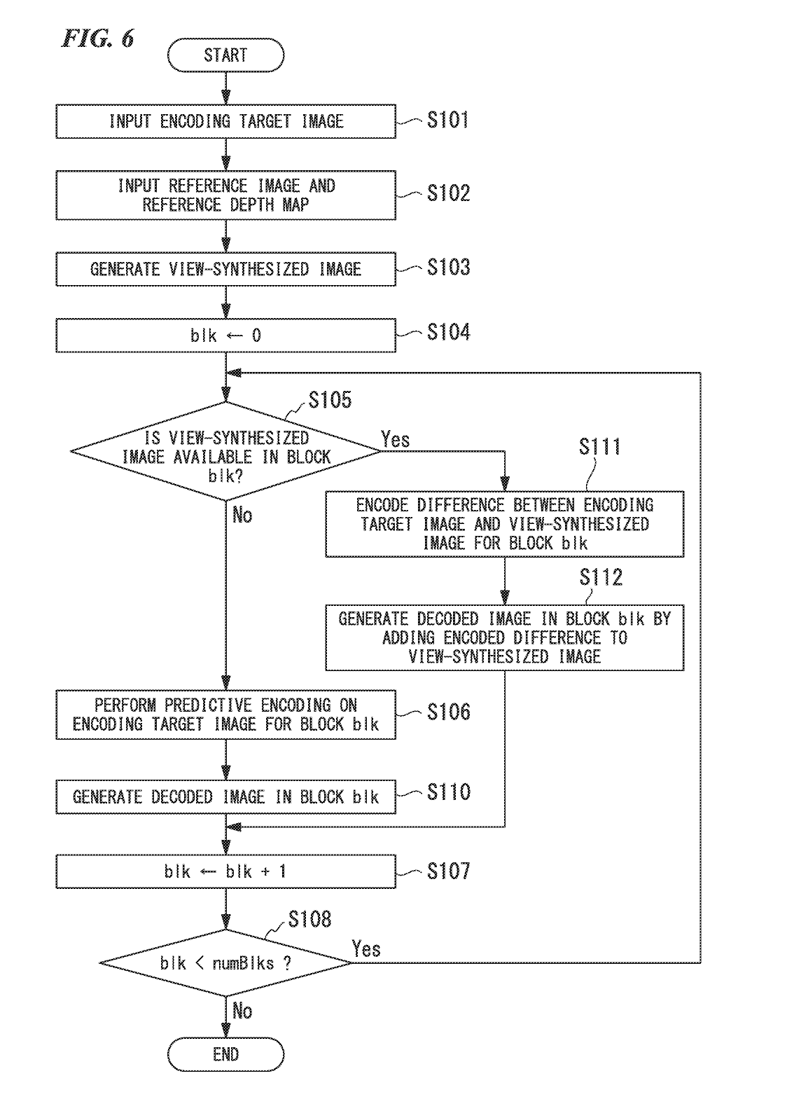

It is to be noted that when a decoded image is generated and stored, the decoded image is generated by adding the encoded difference signal to the view-synthesized image and it is stored as illustrated in FIG. 6 (step S112). FIG. 6 is a flowchart illustrating a modified example of the processing operation illustrated in FIG. 5. Here, the encoded difference signal is a difference signal expressed by the bitstream and is the same as that obtained on the decoding end.

In encoding of a difference signal in general moving-image coding or image coding such as MPEG-2, H.264, or JPEG, encoding for each region is performed by performing frequency transform such as DCT and sequentially applying processes of quantization, binarization, and entropy encoding on a resultant value. In this case, unlike the predictive encoding process in step S106, encoding of information necessary for generation of a predicted image such as a prediction block size, a prediction mode, or a motion/disparity vector is omitted and no bitstream therefor is generated. Thus, as compared with the case in which the prediction mode or the like is encoded for all regions, it is possible to reduce a bit amount and realize efficient coding.

In the above description, no encoding information (prediction information) is generated for a region in which the view-synthesized image is available. However, encoding information of each region which is not included in the bitstream may be generated and the encoding information may be referred to when another frame is encoded. Here, the encoding information is information to be used in generation of a predicted image and/or decoding of a prediction residual such as a prediction block size, a prediction mode, or a motion/disparity vector.

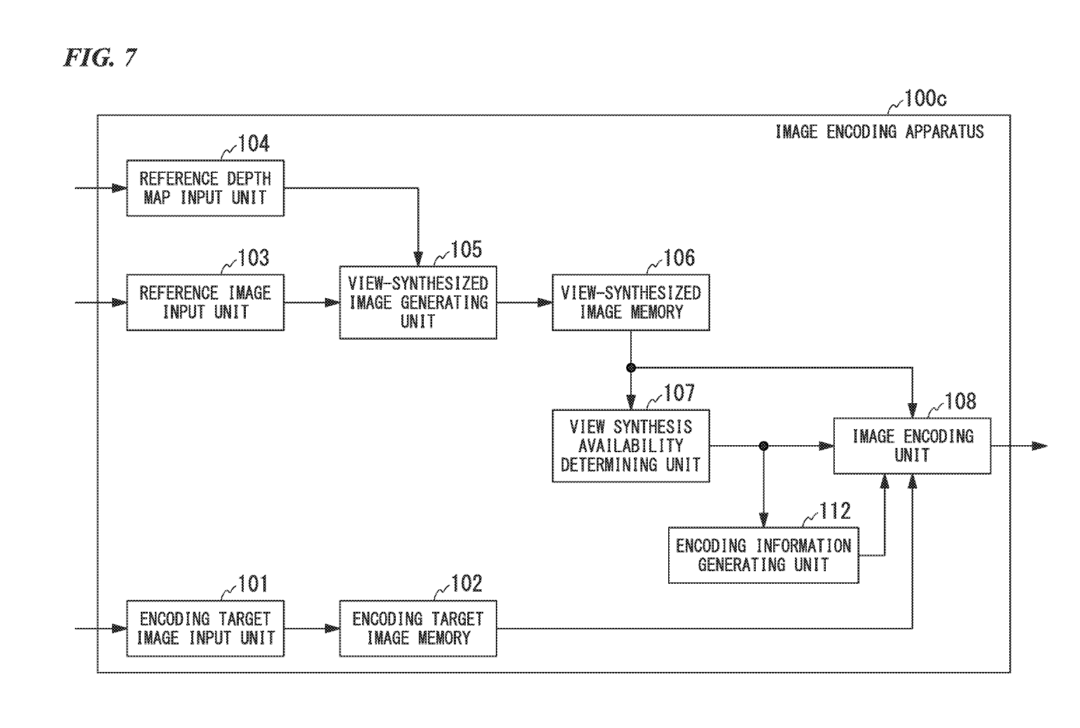

Next, a modified example of the image encoding apparatus illustrated in FIG. 1 will be described with reference to FIG. 7. FIG. 7 is a block diagram illustrating a configuration of the image encoding apparatus in which encoding information is generated for a region for which it is determined that a view-synthesized image is available and the encoding information can be referred to when another region or another frame is encoded. The image encoding apparatus 100c illustrated in FIG. 7 is different from the image encoding apparatus 100a illustrated in FIG. 1 in that an encoding information generating unit 112 is further provided. It is to be noted that the components of FIG. 7 that are the same as those illustrated in FIG. 1 are assigned the same reference signs and a description thereof will be omitted.

The encoding information generating unit 112 generates encoding information for a region for which it is determined that a view-synthesized image is available and outputs it to an image encoding apparatus for encoding another region or another frame. In the present embodiment, it is assumed that another region or another frame is also encoded by the image encoding apparatus 100c and the generated information is passed to the image encoding unit 108.

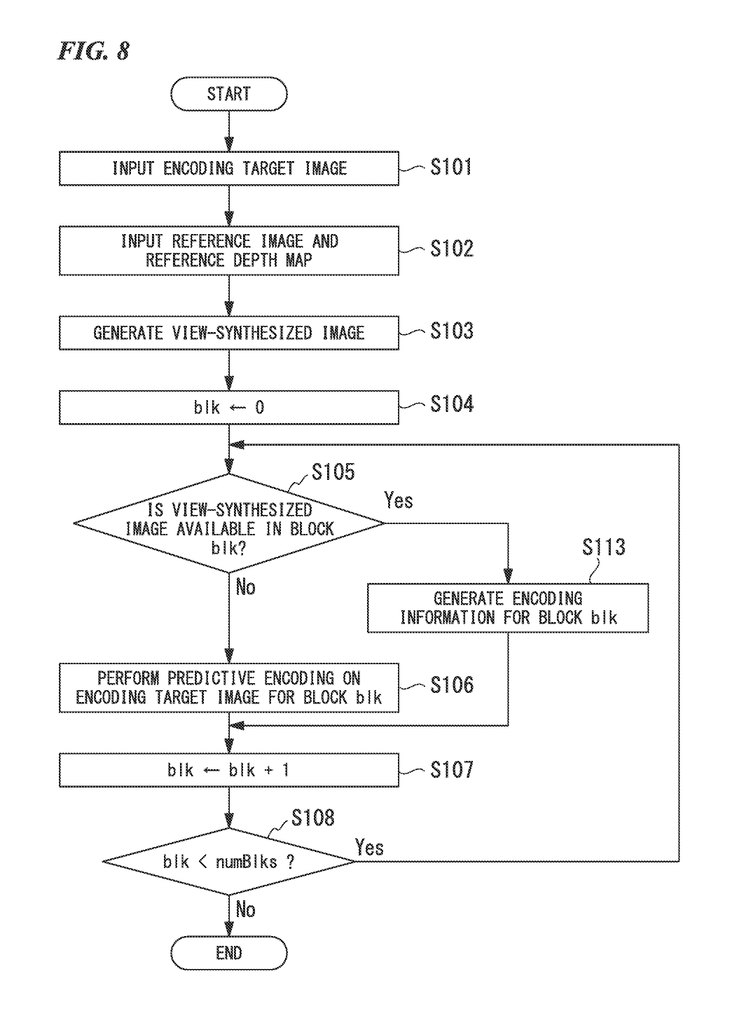

Next, a processing operation of the image encoding apparatus 100c illustrated in FIG. 7 will be described with reference to FIG. 8. FIG. 8 is a flowchart illustrating the processing operation of the image encoding apparatus 100c illustrated in FIG. 7. The processing operation illustrated in FIG. 8 is different from that illustrated in FIG. 2 in that a process (step S113) of generating encoding information for a region blk after it is determined that the view-synthesized image is available in the determination (step S105) of availability of the view-synthesized image is added. It is to be noted that any information may be generated in generation of the encoding information as long as the decoding end can generate the same information.

For example, the largest possible block size or the smallest possible block size may be used as a prediction block size. In addition, a different block size may be set for a different region by making a determination based on the used depth map and/or the generated view-synthesized image. The block size may be adaptively determined so that as large a set of pixels as possible is provided, wherein the pixels have similar pixel values and/or similar depth values.

As the prediction mode and the motion/disparity vector, mode information and a motion/disparity vector indicating prediction using the view-synthesized image when the prediction is performed for each region may be set for all regions. In addition, mode information corresponding to an inter-view prediction mode and a disparity vector obtained from a depth or the like may be set as the mode information and the motion/disparity vector, respectively. The disparity vector may be obtained by performing a search on a reference image using the view-synthesized image for the region as a template.

As another method, an optimum block size and prediction mode may be estimated and generated by regarding the view-synthesized image as the encoding target image and performing analysis. In this case, intra-frame prediction, motion-compensated prediction, or the like may be selected as the prediction mode.

In this manner, information which cannot be obtained from the bitstream is generated and the generated information can be referred to when another frame is encoded, so that it is possible to improve coding efficiency of the other frame. This is because there are also correlations between motion vectors and between prediction modes when similar frames such as temporally continuous frames or frames obtained by photographing the same object are encoded and because redundancy can be removed using these correlations.

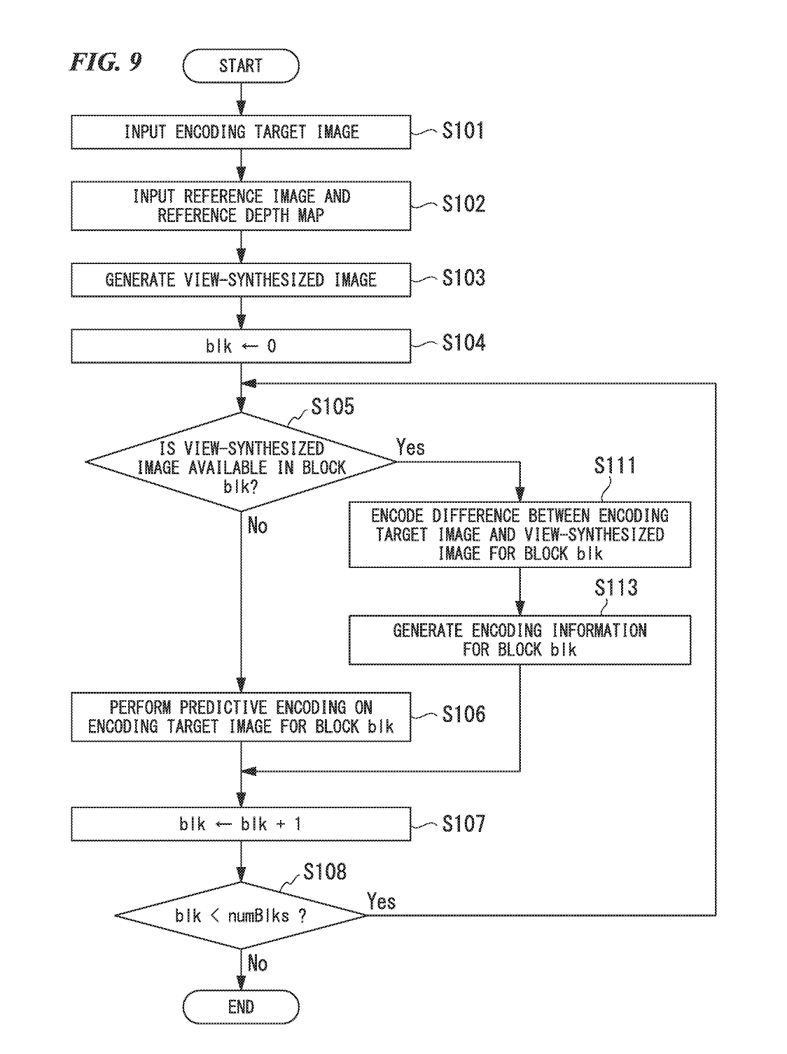

Here, although the case in which no bitstream is generated in a region in which a view-synthesized image is available has been described, encoding of a difference signal between the encoding target image and the view-synthesized image described above may be performed as illustrated in FIG. 9. FIG. 9 is a flowchart illustrating a modified example of the processing operation illustrated in FIG. 8. It is to be noted that when the decoded image of the encoding target image is used in encoding of another region or another frame, the decoded image is generated and stored using a corresponding method as described above after a process for a region blk ends.

In the above-described image encoding apparatus, information about the number of encoded regions for which it is determined that the view-synthesized image is available is not included in a bitstream to be output. However, the number of the regions in which the view-synthesized image is available may be obtained before a process for each block is performed and information indicating the number may be embedded in a bitstream. Hereinafter, the number of the regions in which the view-synthesized image is available is referred to as the number of view synthesis available regions. It is to be noted that because it is obvious that the number of the regions in which the view-synthesized image is unavailable may be used, the case in which the number of regions in which the view-synthesized image is available is used will be described.

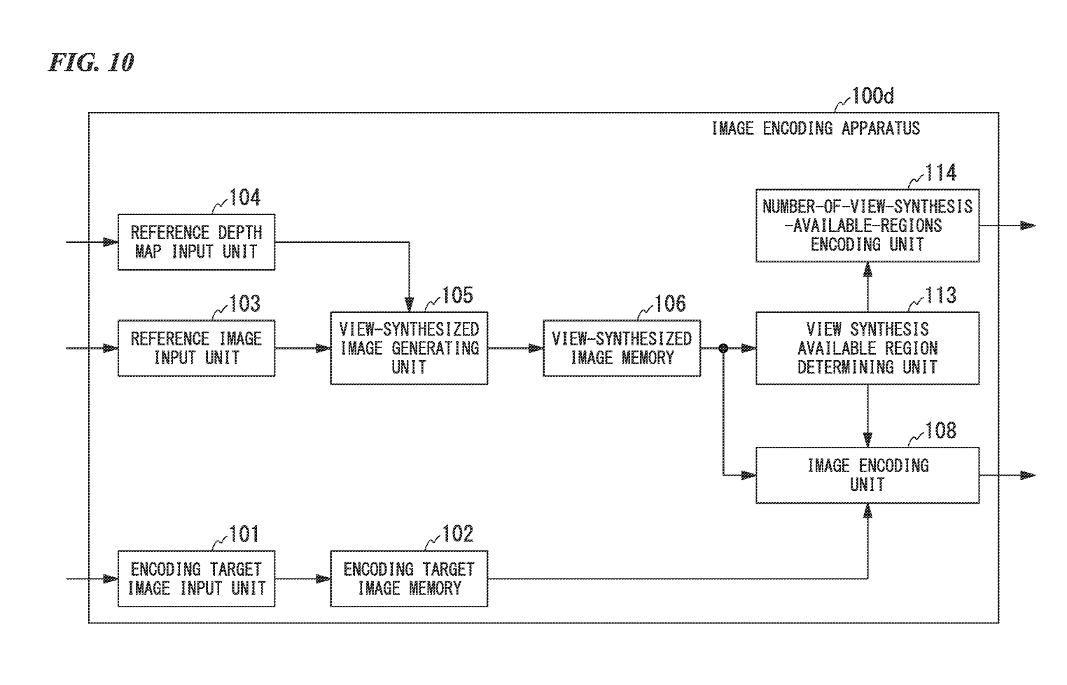

Next, a modified example of the image encoding apparatus illustrated in FIG. 1 will be described with reference to FIG. 10. FIG. 10 is a block diagram illustrating a configuration of an image encoding apparatus in which the number of view synthesis available regions is obtained and encoded. The image encoding apparatus 100d illustrated in FIG. 10 is different from the image encoding apparatus 100a illustrated in FIG. 1 in that a view synthesis available region determining unit 113 and a number-of-view-synthesis-available-regions encoding unit 114 are provided in place of the view synthesis availability determining unit 107. It is to be noted that the components of FIG. 10 that are the same as those of the image encoding apparatus 100a illustrated in FIG. 1 are assigned the same reference signs and a description thereof will be omitted.

The view synthesis available region determining unit 113 determines whether the view-synthesized image is available for each of regions into which the encoding target image is divided for each of the regions. The number-of-view-synthesis-available-regions encoding unit 114 encodes the number of regions for which the view synthesis available region determining unit 113 determines that the view-synthesized image is available.

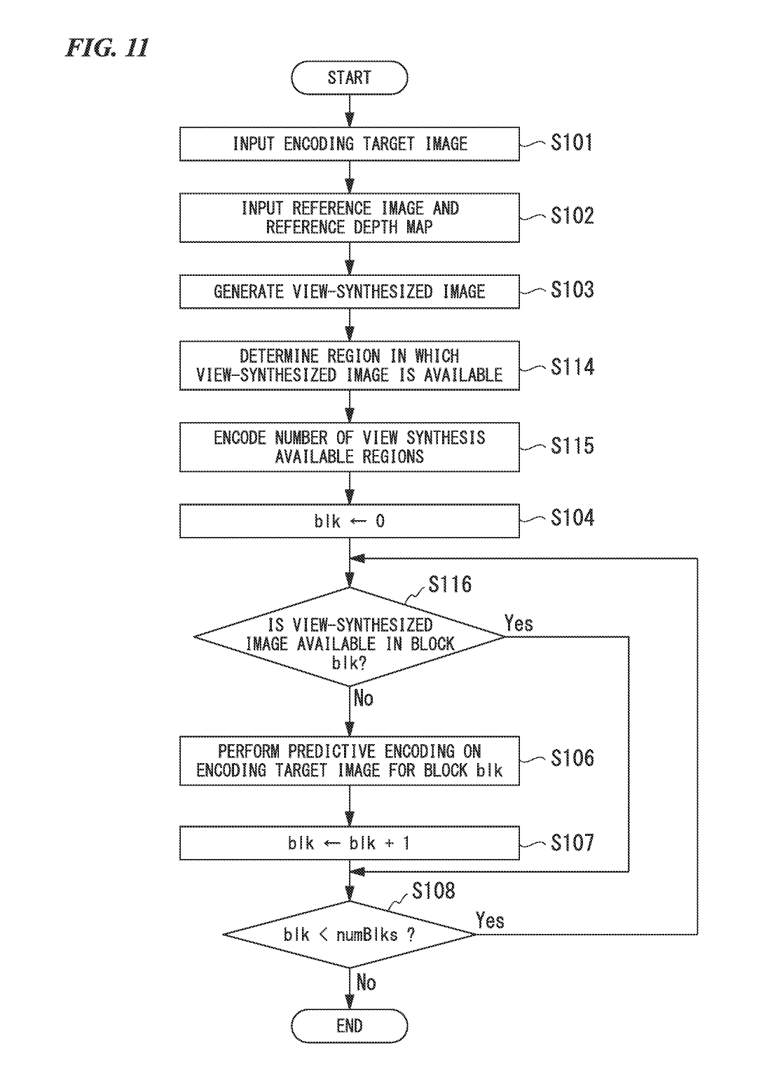

Next, a processing operation of the image encoding apparatus 100d illustrated in FIG. 10 will be described with reference to FIG. 11. FIG. 11 is a flowchart illustrating a processing operation when the image encoding apparatus 100d illustrated in FIG. 10 encodes the number of view synthesis available regions. The processing operation illustrated in FIG. 11 is different from that illustrated in FIG. 2 in that regions in which the view-synthesized image is available are determined (step S114) after the view-synthesized image is generated and the number of view synthesis available regions, which is the number of the regions, is encoded (step S115). A bitstream of an encoding result becomes part of an output of the image encoding apparatus 100d. In addition, a determination (step S116) of whether the view-synthesized image is available to be made for each region is made in the same method as that of the determination of the above-described step S114. It is to be noted that a map indicating whether the view-synthesized image is available in each region may be generated in step S114 and it may be determined whether the view-synthesized image is available by referring to the map in step S116.

It is to be noted that any method may be used in the determination of the region in which the view-synthesized image is available. However, it is necessary for the decoding end to be able to identify the region using a similar criterion. For example, it may be determined whether the view-synthesized image is available based on a predetermined threshold value for the number of pixels included in an occlusion region, quality of the view-synthesized image, or the like. At this time, the threshold value may be determined in accordance with a target bit rate and/or quality and a region in which the view-synthesized image is available may be controlled. It is to be noted that although it is not necessary to encode the used threshold value, the threshold value may be encoded and the encoded threshold value may be transmitted.

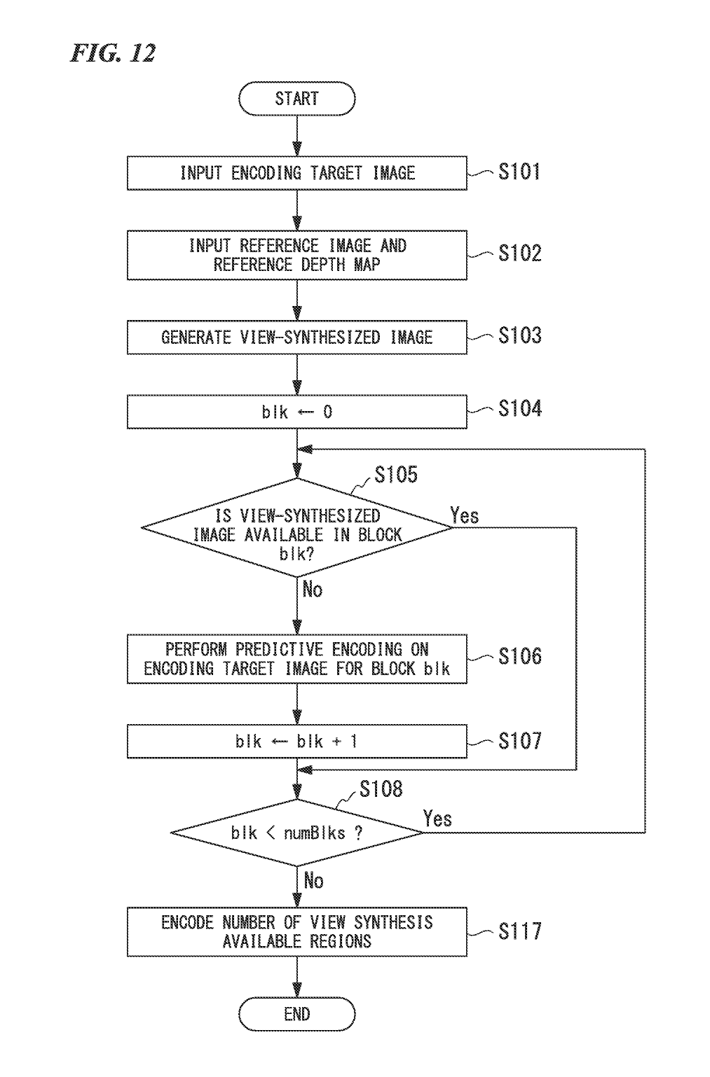

Here, although the image encoding apparatus is assumed to output two types of bitstreams, an output of the image encoding unit 108 and an output of the number-of-view-synthesis-available-regions encoding unit 114 may be multiplexed and a resultant bitstream may be used as an output of the image encoding apparatus. In addition, although the number of the view synthesis available regions is encoded before encoding of each region is performed in the processing operation illustrated in FIG. 11, after encoding is performed in accordance with the processing operation illustrated in FIG. 2, the number of regions for which it is determined that the view-synthesized image is available as a result of the encoding may be encoded (step S117) as illustrated in FIG. 12. FIG. 12 is a flowchart illustrating a modified example of the processing operation illustrated in FIG. 11.

Further, although the case in which the encoding process is omitted in a region for which it is determined that the view-synthesized image is available has been described here, it is obvious that the method for encoding the number of the view synthesis available regions may be combined with the methods described with reference to FIGS. 3 to 9.

By including the number of the view synthesis available regions in the bitstream in this manner, even if a reference image and/or reference depth map obtained in the encoding end are different from those obtained in the decoding end due to an error, it is possible to prevent a reading error of a bitstream due to the error from occurring. It is to be noted that if it is determined that the view-synthesized image is available in regions greater in number than regions assumed in encoding, a bit to be originally read in a frame in question is not read, an incorrect bit is determined as a leading bit in decoding of the next frame or the like, and normal bit reading becomes impossible. In contrast, if it is determined that the view-synthesized image is available in regions fewer in number than regions assumed in encoding, an attempt to perform a decoding process is made using a bit for the next frame or the like and normal bit reading from the frame in question becomes impossible.

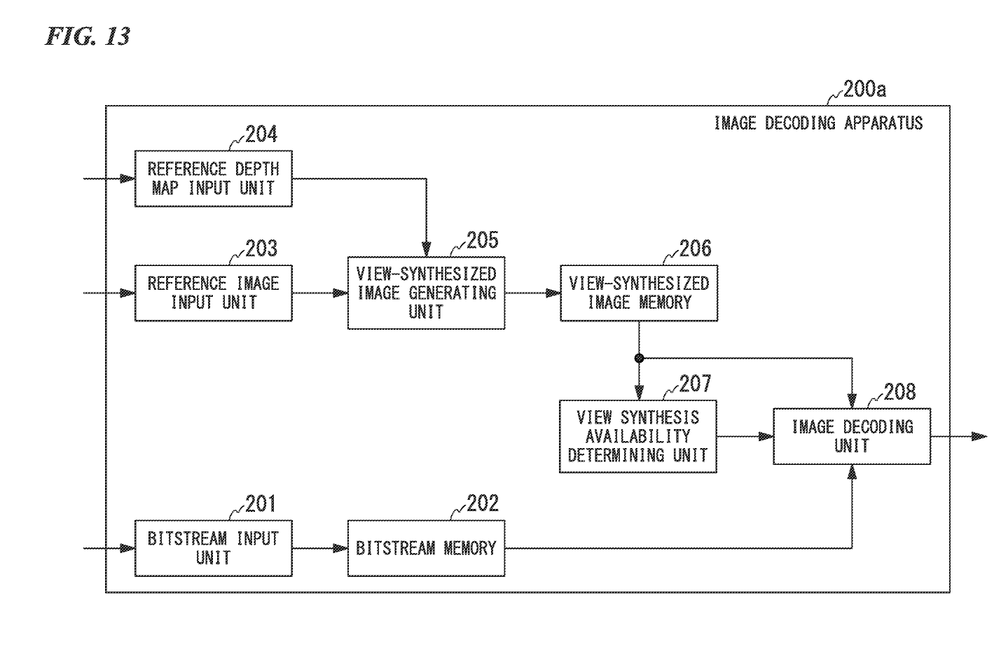

Next, an image decoding apparatus in the present embodiment will be described. FIG. 13 is a block diagram illustrating a configuration of the image decoding apparatus in the present embodiment. As illustrated in FIG. 13, the image decoding apparatus 200a includes a bitstream input unit 201, a bitstream memory 202, a reference image input unit 203, a reference depth map input unit 204, a view-synthesized image generating unit 205, a view-synthesized image memory 206, a view synthesis availability determining unit 207, and an image decoding unit 208.

The bitstream input unit 201 inputs a bitstream of an image serving as a decoding target. Hereinafter, the image serving as the decoding target is referred to as a decoding target image. Here, the decoding target image indicates an image of the camera B. In addition, hereinafter, a camera (here, the camera B) capturing the decoding target image is referred to as a decoding target camera. The bitstream memory 202 stores the bitstream for the input decoding target image. The reference image input unit 203 inputs an image to be referred to when a view-synthesized image (disparity-compensated image) is generated. Hereinafter, the image input here is referred to as a reference image. Here, an image of the camera A is assumed to be input.

The reference depth map input unit 204 inputs a depth map to be referred to when the view-synthesized image is generated. Here, it is assumed that a depth map for the reference image is input, but a depth map for another camera may be input. Hereinafter, this depth map is referred to as a reference depth map. It is to be noted that the depth map represents a three-dimensional position of an object shown in each pixel of a corresponding image. As long as the three-dimensional position is obtained through information such as separately given camera parameters, the depth map may be any information. For example, it is possible to use a distance from a camera to an object, a coordinate value for an axis which is not parallel to an image plane, or a disparity amount for another camera (for example, the camera B). In addition, because it is only necessary to obtain the disparity amount here, the disparity map directly expressing the disparity amount may be used instead of the depth map. It is to be noted that although the depth map is given in the form of an image here, the depth map need not be in the form of an image as long as similar information is obtained. Hereinafter, a camera (here, the camera A) corresponding to the reference depth map is referred to as a reference depth camera.

The view-synthesized image generating unit 205 obtains a corresponding relationship between a pixel of the decoding target image and a pixel of the reference image using the reference depth map and generates a view-synthesized image for the decoding target image. The view-synthesized image memory 206 stores the generated view-synthesized image for the decoding target image. The view synthesis availability determining unit 207 determines whether the view-synthesized image is available for each of regions into which the decoding target image is divided for each of the regions. For each of the regions into which the decoding target image is divided, the image decoding unit 208 decodes the decoding target image from a bitstream or generates the decoding target image from the view-synthesized image based on the determination of the view synthesis availability determining unit 207, and outputs the decoding target image.

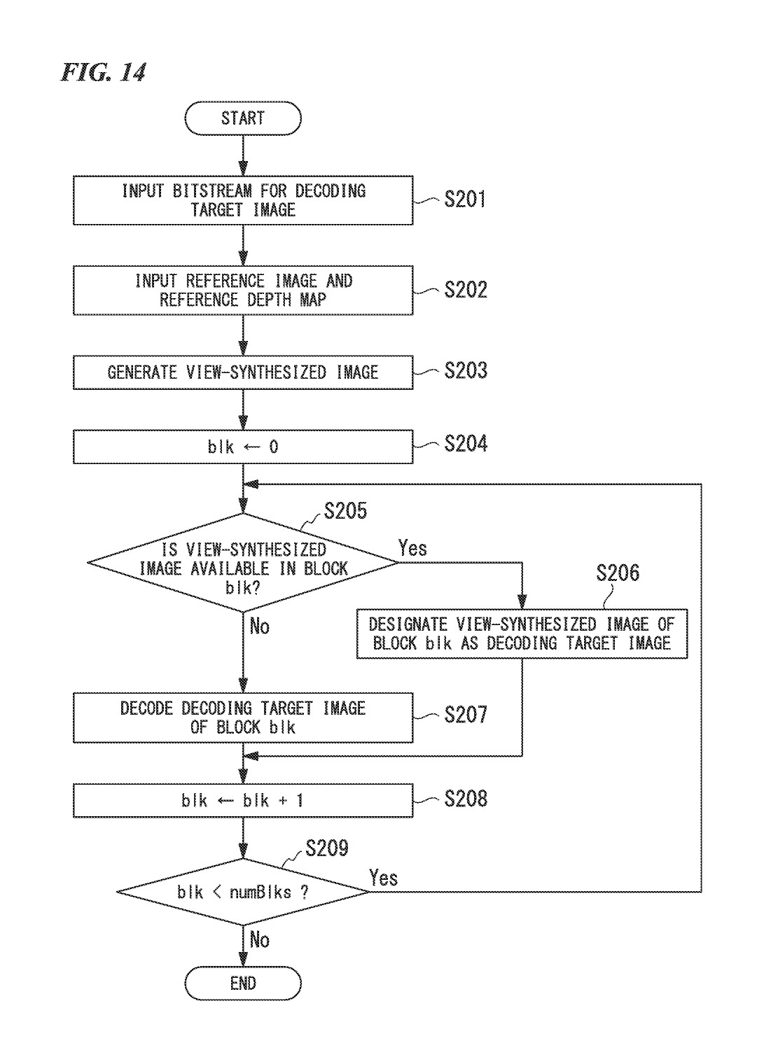

Next, an operation of the image decoding apparatus 200a illustrated in FIG. 13 will be described with reference to FIG. 14. FIG. 14 is a flowchart illustrating the operation of the image decoding apparatus 200a illustrated in FIG. 13. First, the bitstream input unit 201 inputs a bitstream obtained by encoding a decoding target image and stores the input bitstream in the bitstream memory 202 (step S201). Next, the reference image input unit 203 inputs a reference image and outputs the input reference image to the view-synthesized image generating unit 205, and the reference depth map input unit 204 inputs a reference depth map and outputs the input reference depth map to the view-synthesized image generating unit 205 (step S202).

It is to be noted that the reference image and the reference depth map input in step S202 are assumed to be the same as those used on the encoding end. This is because the occurrence of coding noise such as a drift is suppressed by using exactly the same information as that obtained by the image encoding apparatus. However, when this occurrence of coding noise is allowed, a reference image and a depth map different from those used in encoding may be input. In relation to the reference depth map, for example, a depth map estimated by applying stereo matching or the like to a multi-view image decoded for a plurality of cameras, a depth map estimated using a decoded disparity vector, a motion vector, or the like may be used in addition to a separately decoded depth map.

Next, the view-synthesized image generating unit 205 generates a view-synthesized image Synth for the decoding target image and stores the generated view-synthesized image Synth in the view-synthesized image memory 206 (step S203). The process here is the same as the above-described step S103. It is to be noted that although it is necessary to use the same method as that used in encoding in order to suppress the occurrence of coding noise such as a drift, a method different from that used in encoding may be used when the occurrence of such coding noise is allowed.

Next, when the view-synthesized image is obtained, the decoding target image is decoded or generated while it is determined whether the view-synthesized image is available for each of the regions into which the decoding target image is divided. That is, after a variable blk indicating an index of each of the regions into which the decoding target image is divided is initialized to zero, wherein each of the regions is a unit in which a decoding process is performed (step 204), the following process (steps S205 to S207) is iterated until blk reaches the number of regions numBlks within the decoding target image (step S209) while blk is incremented by 1 (step S208).

In the process to be performed for each of the regions into which the decoding target image is divided, first, the view synthesis availability determining unit 207 determines whether the view-synthesized image is available for the region blk (step S205). The process here is the same as the above-described step S105.

If it is determined that the view-synthesized image is available, the view-synthesized image of the region blk is designated as a decoding target image (step S206). In contrast, if it is determined that the view-synthesized image is unavailable, the image decoding unit 208 decodes a decoding target image from the bitstream while generating a predicted image in a designated method (step S207). It is to be noted that the obtained decoding target image becomes an output of the image decoding apparatus 200a. When the decoding target image is used to decode another frame, such as when the present invention is used in moving-image decoding or multi-view image decoding, the decoding target image is stored in a separately defined decoded image memory.

When the decoding target image is decoded from the bitstream, a method corresponding to a scheme used in encoding is used. For example, when encoding is performed using a scheme based on H.264/AVC disclosed in Non-Patent Document 1, information indicating a prediction method and a prediction residual is decoded from the bitstream and the decoding target image is decoded by adding the prediction residual to a predicted image generated in accordance with the decoded prediction method. It is to be noted that when the view-synthesized image is excluded from candidates for the predicted image in encoding by deleting an entry for the view-synthesized image from a table for identifying a prediction mode or using a table in which there is no entry for the view-synthesized image, it is necessary to perform a decoding process through a similar process by deleting an entry for the view-synthesized image from the table for identifying the prediction mode or perform the decoding process in accordance with a table in which there is no entry for the view-synthesized image from the beginning.

Here, the bitstream for the image signal is input to the image decoding apparatus 200a. That is, it is assumed that a parameter set indicating information such as the size of an image and a header are analyzed outside the image decoding apparatus 200a, if necessary, and the image decoding apparatus 200a is notified of information necessary for decoding.

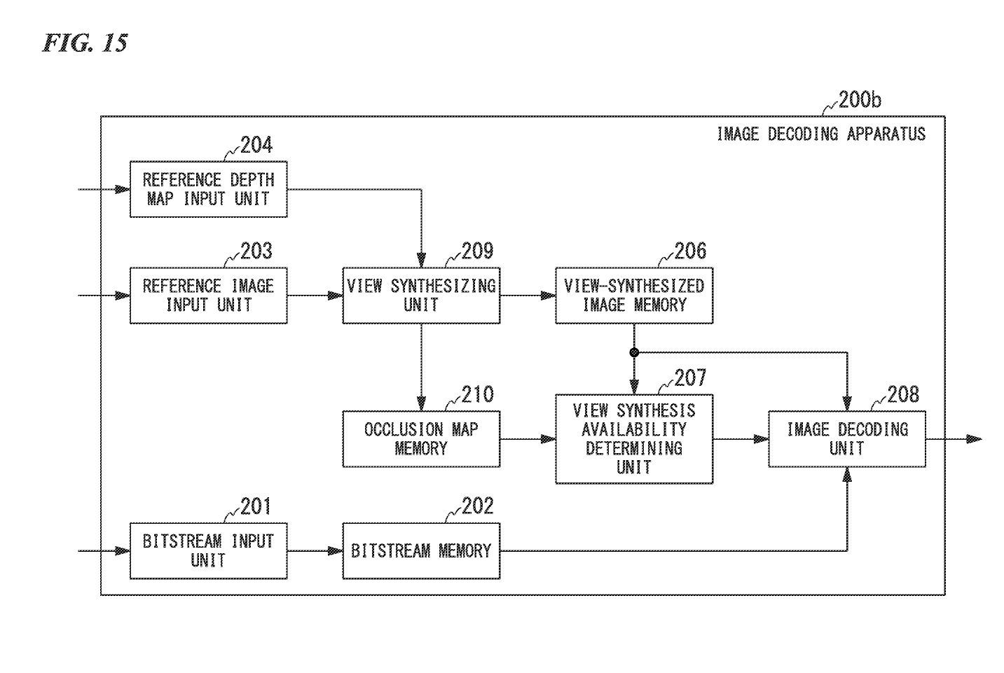

In step S205, an occlusion map may be generated and used to determine whether the view-synthesized image is available. An example of a configuration of the image decoding apparatus in this case is illustrated in FIG. 15. FIG. 15 is a block diagram illustrating the configuration of the image decoding apparatus when the occlusion map is generated and used to determine whether the view-synthesized image is available. The image decoding apparatus 200b illustrated in FIG. 15 is different from the image decoding apparatus 200a illustrated in FIG. 13 in that a view synthesizing unit 209 and an occlusion map memory 210 are provided in place of the view-synthesized image generating unit 205. It is to be noted that the components of FIG. 15 that are the same as those of the image decoding apparatus 200a illustrated in FIG. 13 are assigned the same reference signs and a description thereof will be omitted.

The view synthesizing unit 209 obtains a corresponding relationship between a pixel of the decoding target image and a pixel of the reference image using the reference depth map and generates the view-synthesized image and the occlusion map for the decoding target image. Here, the occlusion map represents whether it is possible to map an object shown in each pixel of the decoding target image onto the reference image. It is to be noted that any method may be used in generation of the occlusion map as long as the same process as that of the encoding end is performed. The occlusion map memory 210 stores the generated occlusion map.

As one of methods for generating a view-synthesized image, there is a technique of generating a certain pixel value by performing spatio-temporal prediction on an occlusion region. This process is referred to as inpainting. In this case, a pixel of which pixel value is generated by the inpainting may be used as an occlusion region or it may not be used as an occlusion region. It is to be noted that when the pixel of which pixel value is generated by the inpainting is handled as the occlusion region, it is necessary to generate the occlusion map because it is impossible to use the view-synthesized image for a determination of the occlusion.

When it is determined whether the view-synthesized image is available using the occlusion map, the view-synthesized image may be generated for each region, rather than generating the view-synthesized image for the entire decoding target image. By doing so, it is possible to reduce a memory amount for storing the view-synthesized image and the computational complexity. However, it is necessary to be able to create the view-synthesized image for each region in order to obtain such an effect.

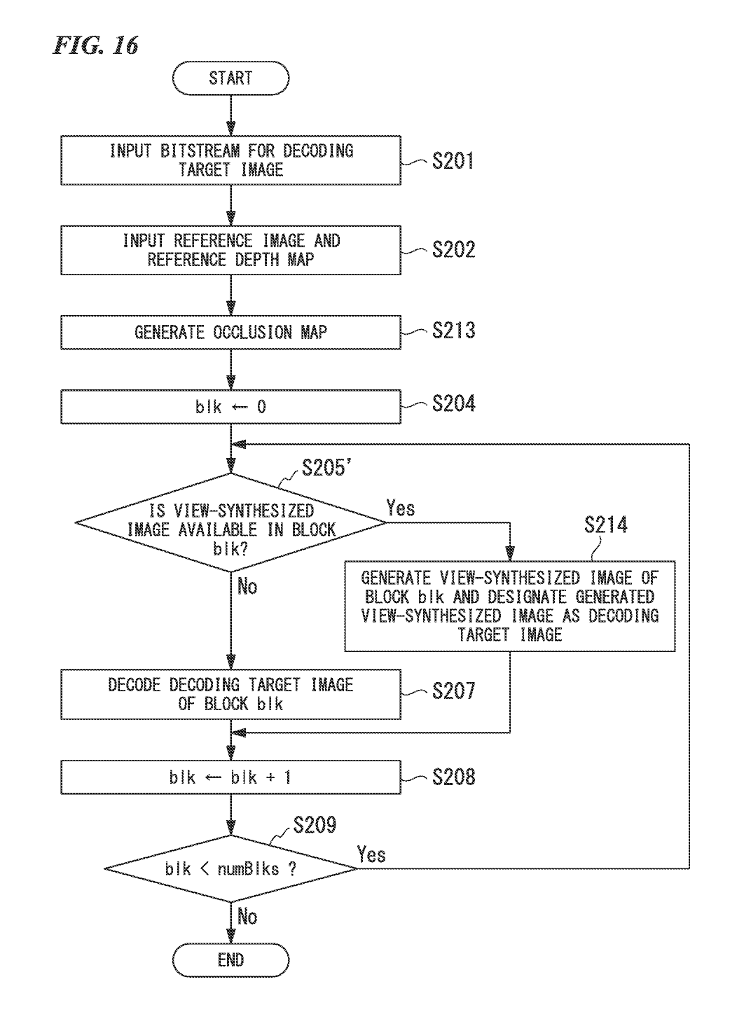

Next, a processing operation of the image decoding apparatus illustrated in FIG. 15 will be described with reference to FIG. 16. FIG. 16 is a flowchart illustrating the processing operation when the image decoding apparatus 200b illustrated in FIG. 15 generates a view-synthesized image for each region. As illustrated in FIG. 16, an occlusion map is generated in units of frames (step S213) and it is determined whether the view-synthesized image is available using the occlusion map (step S205′). Thereafter, the view-synthesized image is generated for a region for which it is determined that the view-synthesized image is available and the generated view-synthesized image is designated as the decoding target image (step S214).

As a situation in which the view-synthesized image can be created for each region, there is a situation in which a depth map for the decoding target image is obtained. For example, the depth map for the decoding target image may be given as a reference depth map or the depth map for the decoding target image may be generated from the reference depth map and used in generation of the view-synthesized image. It is to be noted that when the depth map for the view-synthesized image is generated from the reference depth map, a synthesized depth map may be initialized to a depth value which cannot be taken, and then the synthesized depth map may be generated in accordance with a projection process for each pixel, thereby the synthesized depth map may also be used as an occlusion map.

In the above description, the view-synthesized image is directly used as the decoding target image for a region in which the view-synthesized image is available; however, if a difference signal between the decoding target image and the view-synthesized image is encoded in the bitstream, the decoding target image may be decoded using the difference signal. It is to be noted that the difference signal is information for correcting an error of the view-synthesized image for the decoding target image, and it may be expressed as a simple difference or it may be expressed as a remainder of the decoding target image. However, the expression method used in encoding should be known. For example, a specific expression may be always used or information indicating the expression method may be encoded for each frame. In the latter case, it is necessary to decode information indicating an expression format from the bitstream at an appropriate timing. In addition, a different expression method for a different pixel or frame may be used by determining the expression method using the same information as the encoding end such as the view-synthesized image, the reference depth map, or the occlusion map.

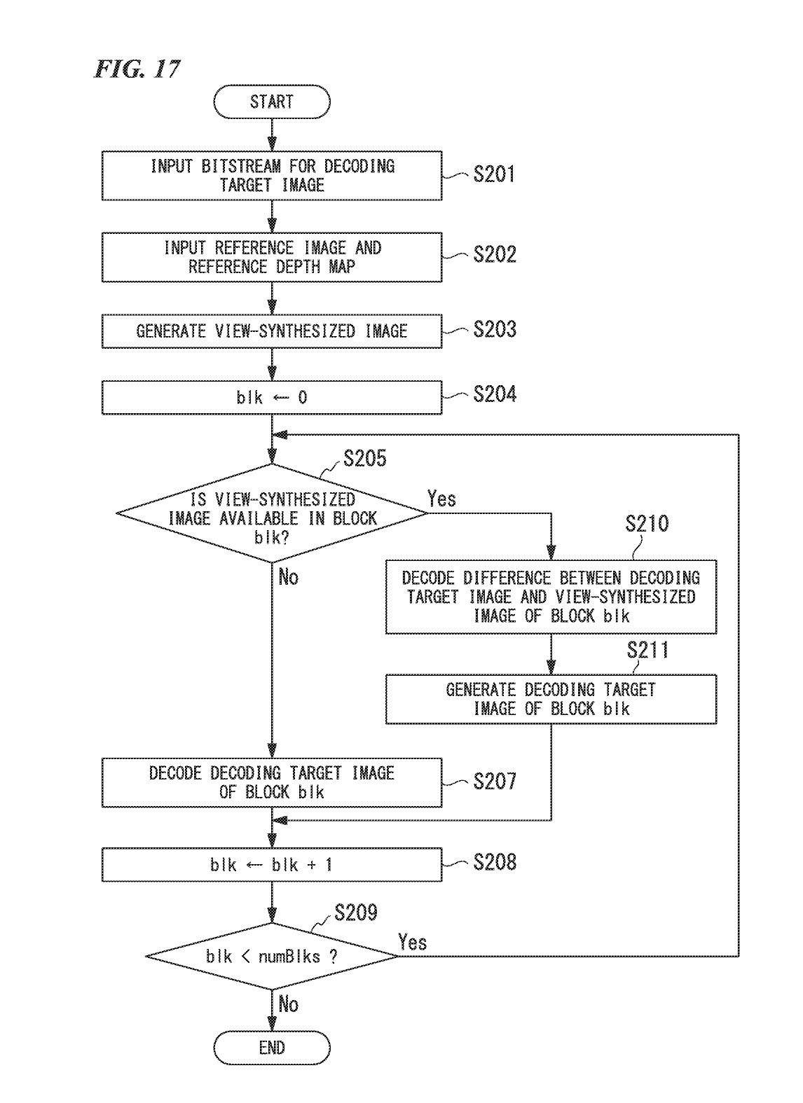

FIG. 17 is a flowchart illustrating a processing operation when a difference signal between a decoding target image and a view-synthesized image is decoded from a bitstream for a region in which the view-synthesized image is available. The processing operation illustrated in FIG. 17 is different from that illustrated in FIG. 14 in that steps S210 and S211 are performed in place of step S206, and the rest is the same. The steps of FIG. 17 of performing the same processes as those illustrated in FIG. 14 are assigned the same reference signs and a description thereof will be omitted.

If it is determined that a view-synthesized image is available for a region blk in the flow illustrated in FIG. 17, a difference signal between a decoding target image and a view-synthesized image is decoded from a bitstream (step S210). The process here uses a method corresponding to the process used on the encoding end. For example, when encoding is performed using the same scheme as encoding of a difference signal in general moving-image coding or image coding such as MPEG-2, H.264, or JPEG, the difference signal is decoded by performing inverse binarization, inverse quantization, and inverse frequency transform such as an inverse discrete cosine transform (IDCT) on a value obtained by performing entropy decoding on a bitstream.

Next, a decoding target image is generated using the view-synthesized image and the decoded difference signal (step S211). The process here is performed in accordance with the expression method of the difference signal. For example, when the difference signal is expressed as a simple difference, the decoding target image is generated by adding the difference signal to the view-synthesized image and performing a clipping process in accordance with a range of a pixel value. When the difference signal indicates the remainder of the decoding target image, the decoding target image is generated by obtaining a pixel value which is closest to that of the view-synthesized image and is equal to the remainder of the difference signal. In addition, when the difference signal is an error correction code, the decoding target image is generated by correcting the error of the view-synthesized image using the difference signal.

It is to be noted that unlike the decoding process in step S207, a process of decoding information necessary for generation of a predicted image such as a prediction block size, a prediction mode, or a motion/disparity vector from the bitstream is not performed. Thus, as compared with when the prediction mode or the like is encoded for all regions, it is possible to reduce a bit amount and realize efficient coding.

In the above description, no encoding information (prediction information) is generated for a region in which the view-synthesized image is available. However, encoding information of each region which is not included in the bitstream may be generated and the generated encoding information may be referred to when another frame is decoded. Here, the encoding information is information to be used in generation of a predicted image and/or decoding of a prediction residual such as a prediction block size, a prediction mode, or a motion/disparity vector.

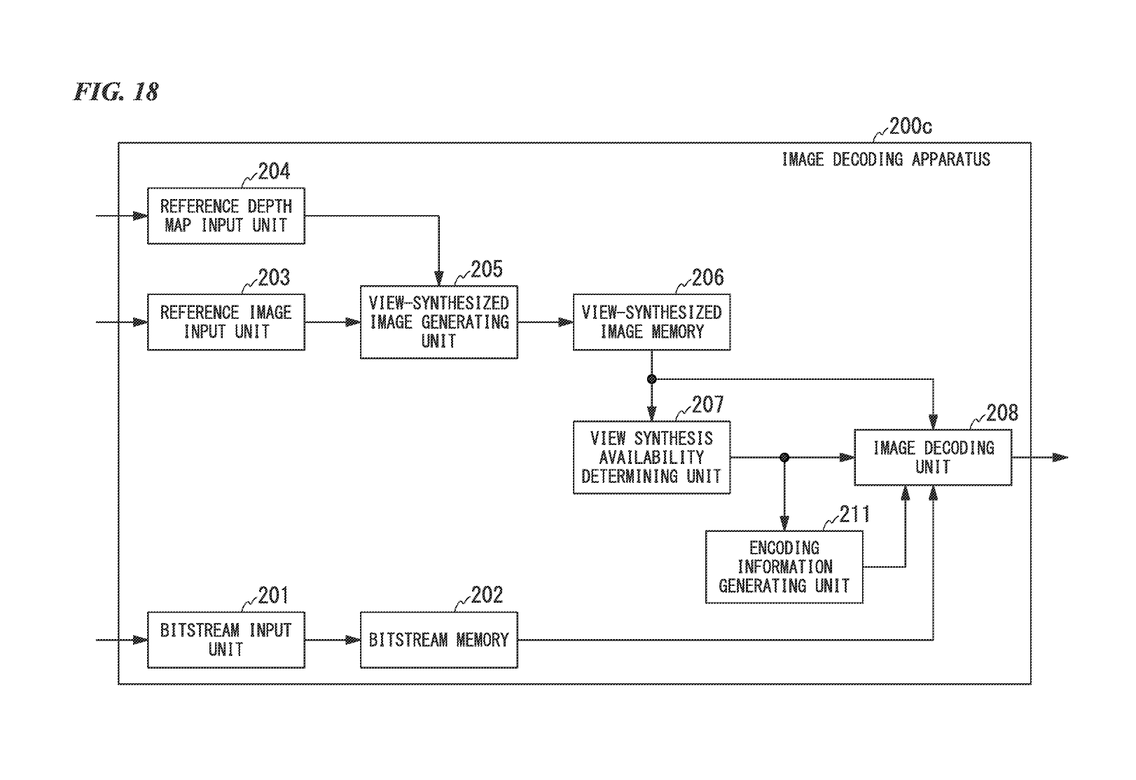

Next, a modified example of the image decoding apparatus illustrated in FIG. 13 will be described with reference to FIG. 18. FIG. 18 is a block diagram illustrating a configuration of the image decoding apparatus when encoding information is generated for a region for which it is determined that a view-synthesized image is available and the encoding information can be referred to when another region or another frame is decoded. The image decoding apparatus 200c illustrated in FIG. 18 is different from the image decoding apparatus 200a illustrated in FIG. 13 in that an encoding information generating unit 211 is further provided. It is to be noted that the components of FIG. 18 that are the same as those illustrated in FIG. 13 are assigned the same reference signs and a description thereof will be omitted.

The encoding information generating unit 211 generates encoding information for a region for which it is determined that the view-synthesized image is available and outputs the generated encoding information to the image decoding apparatus for decoding another region or another frame. Here, the case in which decoding of another region or another frame is also performed by the image decoding apparatus 200c is shown and the generated information is passed to the image decoding unit 208.

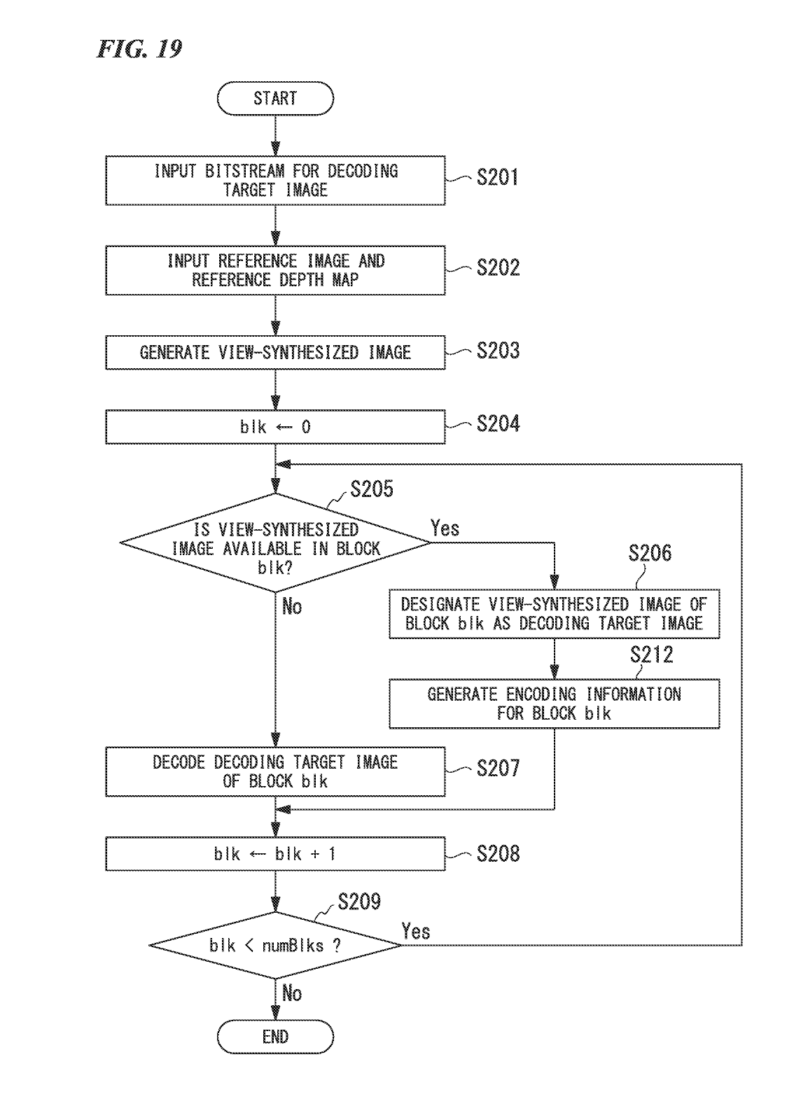

Next, a processing operation of the image decoding apparatus 200c illustrated in FIG. 18 will be described with reference to FIG. 19. FIG. 19 is a flowchart illustrating the processing operation of the image decoding apparatus 200c illustrated in FIG. 18. The processing operation illustrated in FIG. 19 is different from that illustrated in FIG. 14 in that a process (step S212) of generating encoding information for a region blk is added after it is determined that the view-synthesized image is available in the determination (step S205) of availability of the view-synthesized image and the decoding target image is generated. It is to be noted that in the process of generating the encoding information, any information may be generated as long as the same information as that generated on the encoding end is generated.

For example, the largest possible block size or the smallest possible block size may be used as a prediction block size. In addition, a different block size may be set for a different region by making a determination based on the used depth map and/or the generated view-synthesized image. The block size may be adaptively determined so that as large a set of pixels as possible is provided, wherein the pixels have similar pixel values and/or similar depth values.

As the prediction mode and the motion/disparity vector, mode information and motion/disparity vector indicating prediction using the view-synthesized image when the prediction is performed for each region may be set for all regions. In addition, mode information corresponding to an inter-view prediction mode and a disparity vector obtained from a depth or the like may be set as the mode information and the motion/disparity vector, respectively. The disparity vector may be obtained by performing a search on a reference image using the view-synthesized image for the region as a template.

As another method, an optimum block size and prediction mode may be estimated and generated by regarding the view-synthesized image as an image before the decoding target image is encoded and performing analysis. In this case, intra-frame prediction, motion-compensated prediction, or the like may be selected as the prediction mode.

In this manner, information which is not obtained from the bitstream is generated and the generated information can be referred to when another frame is decoded, so that it is possible to improve coding efficiency of another frame. This is because there are also correlations between motion vectors and between prediction modes when similar frames such as temporally continuous frames or frames obtained by photographing the same object are encoded and because redundancy can be removed using these correlations.

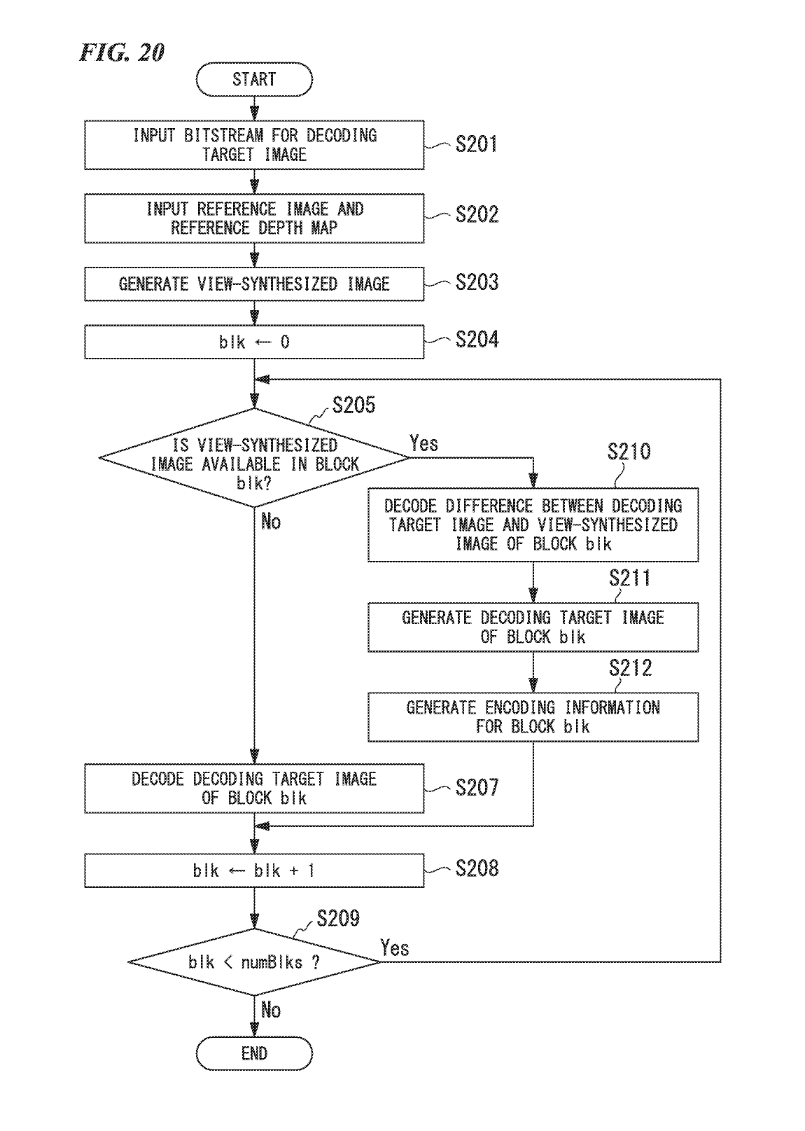

Here, although the case in which the view-synthesized image is designated as a decoding target image in a region in which the view-synthesized image is available has been described, the difference signal between the decoding target image and the view-synthesized image may be decoded from the bitstream (step S210) and the decoding target image may be generated (step S211) as illustrated in FIG. 20. FIG. 20 is a flowchart illustrating a processing operation when a difference signal between a decoding target image and a view-synthesized image is decoded from a bitstream and the decoding target image is generated. In addition, a combination of the method for generating an occlusion map in units of frames and generating the view-synthesized image for each region and the method for generating encoding information described above may be used.

In the above-described image decoding apparatus, information about the number of encoded regions in which the view-synthesized image is available is not included in the input bitstream. However, the number of regions in which the view-synthesized image is available (or the number of unavailable regions) may be decoded from the bitstream and a decoding process may be controlled in accordance with the number. Hereinafter, the decoded number of regions in which the view-synthesized image is available is referred to as the number of view synthesis available regions.

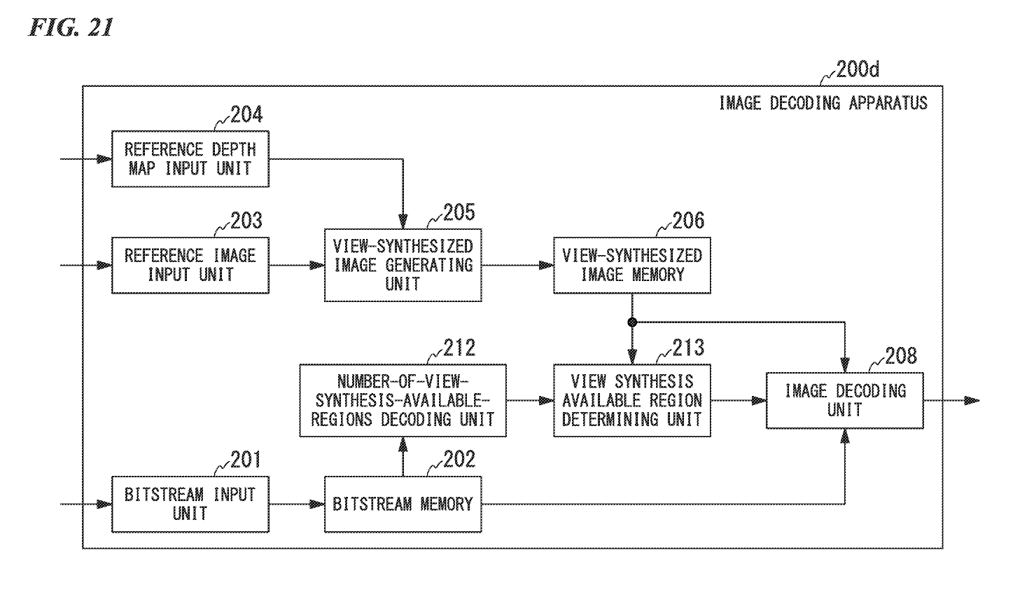

FIG. 21 is a block diagram illustrating a configuration of an image decoding apparatus when the number of view synthesis available regions is decoded from a bitstream. The image decoding apparatus 200d illustrated in FIG. 21 is different from the image decoding apparatus 200a illustrated in FIG. 13 in that a number-of-view-synthesis-available-regions decoding unit 212 and a view synthesis available region determining unit 213 are provided in place of the view synthesis availability determining unit 207. It is to be noted that the components of FIG. 21 that are the same as those of the image decoding apparatus 200a illustrated in FIG. 13 are assigned the same reference signs and a description thereof will be omitted.

The number-of-view-synthesis-available-regions decoding unit 212 decodes the number of regions for which it is determined that the view-synthesized image is available among regions into which the decoding target image is divided from the bitstream. The view synthesis available region determining unit 213 determines whether the view-synthesized image is available for each of the regions into which the decoding target image is divided based on the decoded number of view synthesis available regions.

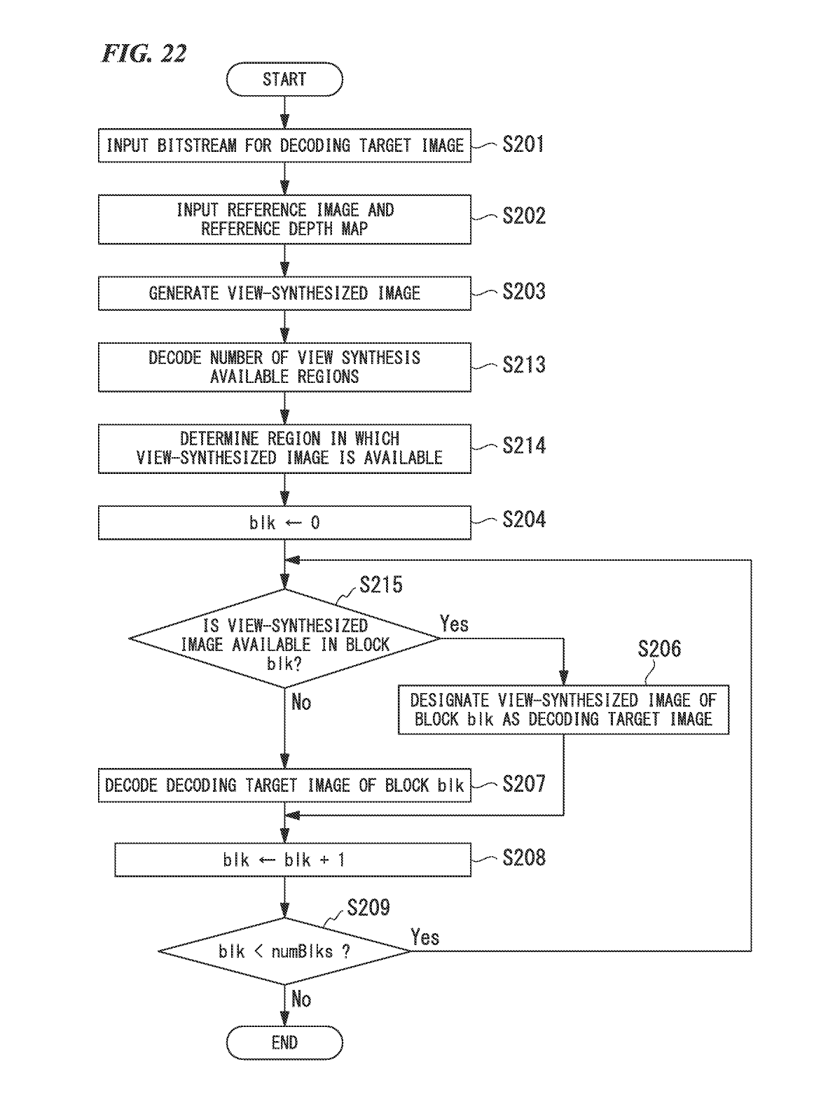

Next, a processing operation of the image decoding apparatus 200d illustrated in FIG. 21 will be described with reference to FIG. 22. FIG. 22 is a flowchart illustrating the processing operation when the number of view synthesis available regions is decoded. The processing operation illustrated in FIG. 22 is different from that illustrated in FIG. 14 in that after the view-synthesized image is generated, the number of regions in which the view-synthesized image is available is decoded from the bitstream (step S213) and it is determined whether the view-synthesized image is available for each of the regions into which the decoding target image is divided using the decoded number of view synthesis available regions (step S214). In addition, the determination (step S215) of whether the view-synthesized image is available to be performed for each region is made in the same method as the determination of step S214.

Any method may be used in the determination of the region in which the view-synthesized image is available. However, it is necessary to determine the region using the same criterion as that of the encoding end. For example, each region may be ranked based on quality of a view-synthesized image and/or the number of pixels included in an occlusion region and a region in which the view-synthesized image is available may be determined in accordance with the number of view synthesis available regions. Thereby, it is possible to control the number of regions in which the view-synthesized image is available in accordance with a target bit rate and/or quality and realize flexible coding from coding in which transmission of a high-quality decoding target image is possible to coding in which transmission of images at a low bit rate is possible.

It is to be noted that a map indicating whether the view-synthesized image is available in each region may be generated in step S214 and it may be determined whether the view-synthesized image is available by referring to the map in step S215. In addition, when no map indicating the availability of the view-synthesized image is generated, a threshold value which satisfies the decoded number of view synthesis available regions may be determined when the set criterion is used in step S214 and the determination of step S215 may be made by determining whether the determined threshold value is satisfied. By doing so, it is possible to reduce the computational complexity related to the availability of the view-synthesized image to be made for each region.

Here, it has been assumed that one type of bitstream is input to the image decoding apparatus, the input bitstream is separated into partial bitstreams including appropriate information, and the appropriate bitstreams are input to the image decoding unit 208 and the number-of-view-synthesis-available-regions decoding unit 212. However, the separation of the bitstream may be performed outside the image decoding apparatus and separate bitstreams may be input to the image decoding unit 208 and the number-of-view-synthesis-available-regions decoding unit 212.

In addition, although the determination of the region in which the view-synthesized image is available is made in view of the entire image before each region is decoded in the above-described processing operation, a determination of whether the view-synthesized image is available for each region may be made in consideration of the determination results of the already processed regions.

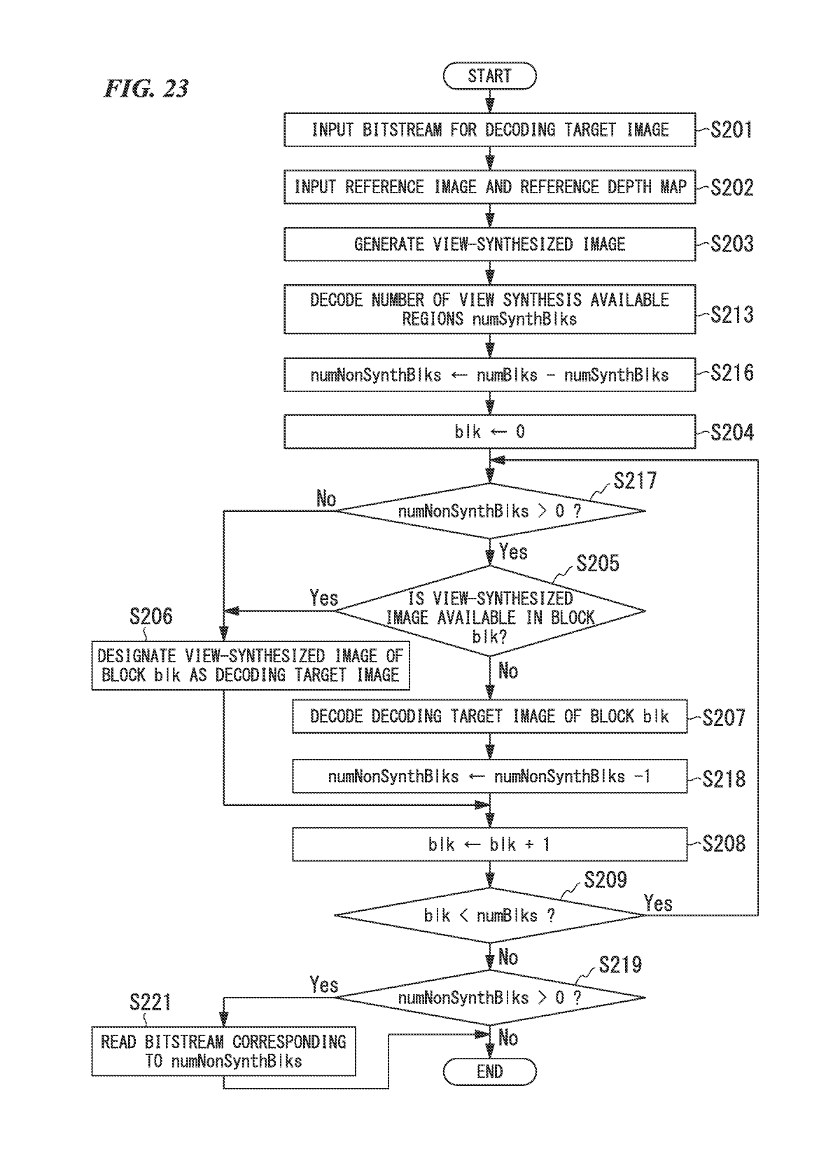

For example, FIG. 23 is a flowchart illustrating a processing operation of performing decoding while counting the number of decoded regions for which it is determined that the view-synthesized image is unavailable. In this processing operation, the number of view synthesis available regions numSynthBlks is decoded (step S213) before the process for each region is performed, and numNonSynthBlks indicating the number of regions other than the view synthesis available regions within the remaining bitstream is obtained (step S216).

In the process for each region, it is first checked whether numNonSynthBlks is greater than 0 (step S217). If numNonSynthBlks is greater than 0, it is determined whether the view-synthesized image is available in each region, similarly to the above description (step S205). In contrast, if numNonSynthBlks is less than or equal to 0 (exactly speaking, 0), a determination of whether the view-synthesized image is available for each region is skipped and a process when the view-synthesized image is available is performed in each region. In addition, every time the process when the view-synthesized image is unavailable is performed, numNonSynthBlks is decremented by 1 (step S218).

After the decoding process is completed for all regions, it is checked whether numNonSynthBlks is greater than 0 (step S219). If numNonSynthBlks is greater than 0, bits corresponding to the number of regions equal to numNonSynthBlks are read from the bitstream (step S221). The read bits may be simply discarded or used to identify an error position.

By doing so, even if a reference image and/or reference depth map obtained in the decoding end are different from those obtained in the encoding end due to an error, it is possible to prevent a reading error of a bitstream due to the error from occurring. Specifically, it is possible to avoid a situation in which it is determined that the view-synthesized image is available in regions greater in number than regions assumed in encoding, a bit to be originally read in a frame in question is not read, an incorrect bit is determined as a leading bit in decoding of the next frame or the like, and normal bit reading becomes impossible. In addition, it is also possible to prevent a situation in which it is determined that the view-synthesized image is available in regions fewer in number than regions assumed in encoding, an attempt to perform a decoding process using a bit for the next frame or the like is made, and normal bit reading from the frame in question becomes impossible

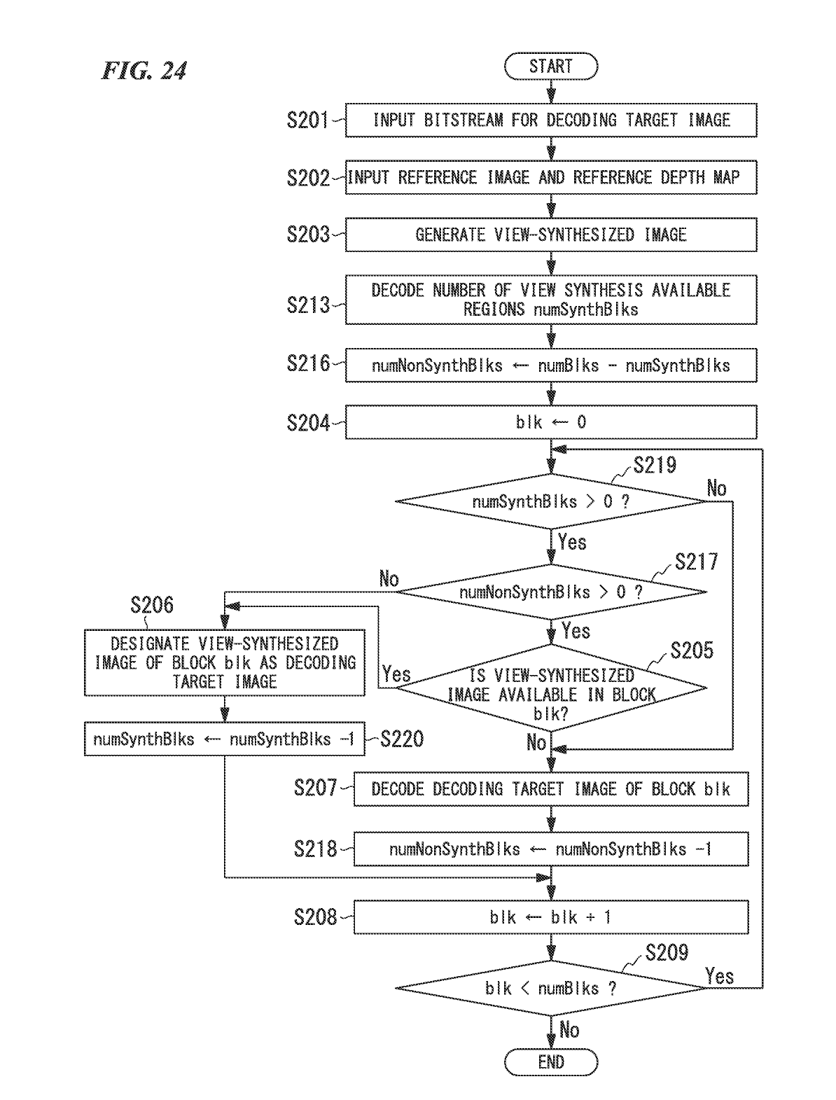

In addition, a processing operation when a process is performed while the number of decoded regions for which it is determined that the view-synthesized image is available as well as the number of decoded regions for which it is determined that the view-synthesized image is unavailable are counted is illustrated in FIG. 24. FIG. 24 is a flowchart illustrating the processing operation of performing the process while counting also the number of decoded regions for which it is determined that the view-synthesized image is available. The processing operation illustrated in FIG. 24 has the same basic processing operation as that illustrated in FIG. 23.

A difference between the processing operation illustrated in FIG. 24 and the processing operation illustrated in FIG. 23 will be described. First, when the process for each region is performed, it is first determined whether numSynthBlks is greater than 0 (step S219). If numSynthBlks is greater than 0, nothing is performed. In contrast, if numSynthBlks is less than or equal to 0 (exactly speaking, 0), a process in which the view-synthesized image is forcibly unavailable in a region in question is performed. In addition, every time the process when the view-synthesized image is available is performed, numSynthBlks is decremented by 1 (step S220). Finally, the decoding process immediately ends when the decoding process has been completed for all regions.

Although the case in which the decoding process is omitted in a region for which it is determined that the view-synthesized image is available has been described here, it is obvious that the methods described with reference to FIGS. 15 to 20 and the method for decoding the number of view synthesis available regions may be combined.

Although a process of encoding and decoding one frame has been described in the above description, the present technique can also be applied to moving-image coding by iterating the process for a plurality of frames. In addition, the present technique is applicable to only a frame or a block of part of a moving image. Further, although the configurations and the processing operations of the image encoding apparatus and the image decoding apparatus have been described in the above description, it is possible to realize an image encoding method and an image decoding method of the present invention through processing operations corresponding to operations of the units of the image encoding apparatus and the image decoding apparatus.

In addition, although the case in which the reference depth map is a depth map for an image captured by a camera different from an encoding target camera or a decoding target camera has been described in the above description, a depth map for an image captured by the encoding target camera or the decoding target camera may be used as the reference depth map.

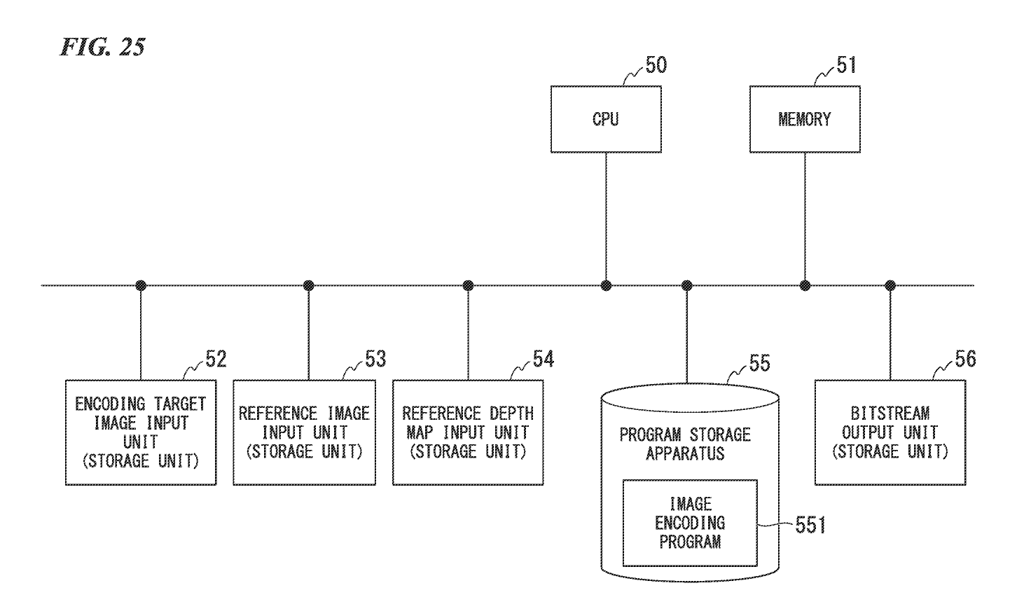

FIG. 25 is block diagram illustrating a hardware configuration when the above-described image encoding apparatuses 100a to 100d are constituted of a computer and a software program. The system illustrated in FIG. 25 has a configuration in which a central processing unit (CPU) 50 which executes the program, a memory 51 such as a random access memory (RAM) which stores the program and data to be accessed by the CPU 50, an encoding target image input unit 52 (which may be a storage unit such as a disk apparatus which stores an image signal) which inputs an image signal of an encoding target from a camera or the like, a reference image input unit 53 (which may be a storage unit such as a disk apparatus which stores an image signal) which inputs an image signal of a reference target from a camera or the like, a reference depth map input unit 54 (which may be a storage unit such as a disk apparatus which stores a depth map) which inputs a depth map for a camera of a different position and/or direction from the camera capturing the encoding target image from a depth camera or the like, a program storage apparatus 55 which stores an image encoding program 551 which is a software program for causing the CPU 50 to execute the image encoding process, and a bitstream output unit 56 (which may be a storage unit such as a disk apparatus which stores a bitstream) which outputs a bitstream generated by executing the image encoding program 551 loaded by the CPU 50 to the memory 51, for example, via a network are connected through a bus.

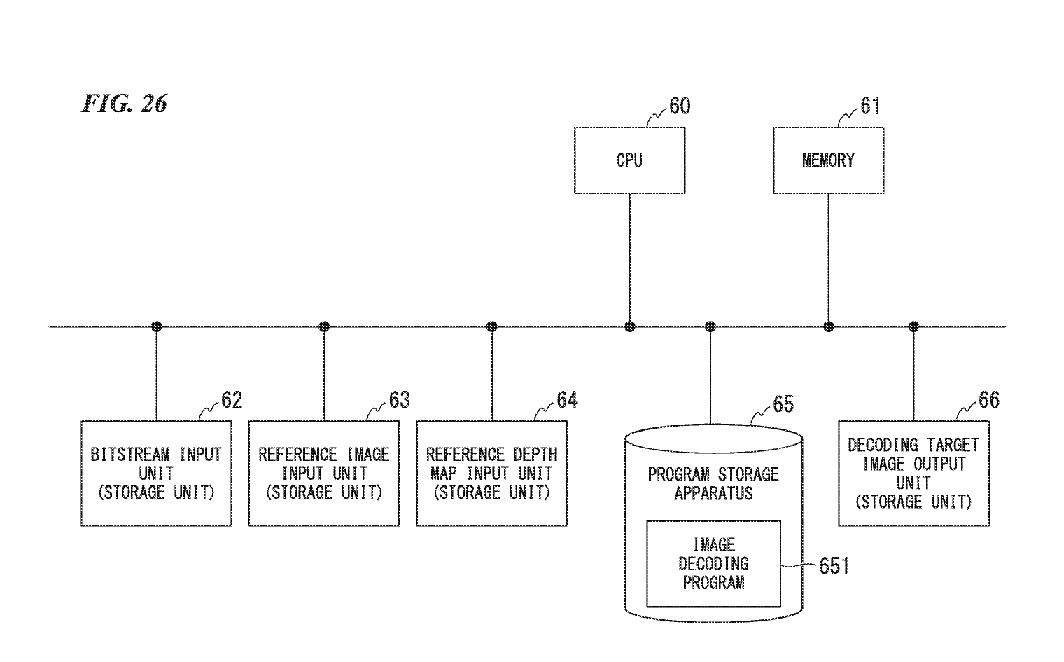

FIG. 26 is a block diagram illustrating a hardware configuration when the above-described image decoding apparatuses 200a to 200d are constituted of a computer and a software program. The system illustrated in FIG. 26 has a configuration in which a CPU 60 which executes the program, a memory 61 such as a RAM which stores the program and data to be accessed by the CPU 60, a bitstream input unit 62 (which may be a storage unit such as a disk apparatus which stores an image signal) which inputs a bitstream encoded by the image encoding apparatus in accordance with the present technique, a reference image input unit 63 (which may be a storage unit such as a disk apparatus which stores an image signal) which inputs an image signal of a reference target from a camera or the like, a reference depth map input unit 64 (which may be a storage unit such as a disk apparatus which store depth information) which inputs a depth map for a camera of a position and/or direction different from a camera capturing the decoding target from a depth camera or the like, a program storage apparatus 65 which stores an image decoding program 651 which is a software program for causing the CPU 60 to execute the image decoding process, and a decoding target image output unit 66 (which may be a storage unit such as a disk apparatus which stores an image signal) which outputs a decoding target image obtained by performing decoding on the bitstream to a reproduction apparatus or the like by executing the image decoding program 651 loaded to the memory 61 by the CPU 60 are connected through a bus.

The image encoding apparatuses 100a to 100d and the image decoding apparatuses 200a to 200d in the above-described embodiments may be realized by a computer. In this case, they may be realized by recording a program for realizing their functions on a computer-readable recording medium and causing a computer system to read and execute the program recorded on the recording medium. It is to be noted that the “computer system” used here is assumed to include an operating system (OS) and hardware such as peripheral devices. In addition, the “computer-readable recording medium” refers to a portable medium such as a flexible disk, a magneto-optical disc, a read only memory (ROM), or a compact disc (CD)-ROM, and a storage apparatus such as a hard disk embedded in the computer system. Further, the “computer-readable recording medium” may also include a computer-readable recording medium for dynamically holding a program for a short time as in a communication line when the program is transmitted via a network such as the Internet or a communication circuit such as a telephone circuit and a computer-readable recording medium for holding the program for a predetermined time as in a volatile memory inside the computer system that functions as a server or a client. In addition, the above-described program may realize part of the above-described functions, it may realize the above-described functions in combination with a program already recorded on the computer system, or it may realize the above-described functions using hardware such as a programmable logic device (PLD) and/or a field programmable gate array (FPGA).

While embodiments of the present invention have been described above with reference to the drawings, it is apparent that the above embodiments are exemplary of the present invention and the present invention is not limited to the above embodiments. Accordingly, additions, omissions, substitutions, and other modifications of structural elements may be made without departing from the technical idea and scope of the present invention.

### INDUSTRIAL APPLICABILITY

The present invention is applicable for use in achieving high coding efficiency with small computational complexity when disparity-compensated prediction is performed on an encoding (decoding) target image using a depth map of an image captured from a position different from that of a camera capturing the encoding (decoding) target image.

### DESCRIPTION OF REFERENCE SIGNS

101 Encoding target image input unit
102 Encoding target image memory
103 Reference image input unit
104 Reference depth map input unit
105 View-synthesized image generating unit
106 View-synthesized image memory
107 View synthesis availability determining unit
108 Image encoding unit
110 View synthesizing unit
111 Occlusion map memory
112 Encoding information generating unit
113 View synthesis available region determining unit
114 Number-of-view-synthesis-available-regions encoding unit
201 Bitstream input unit
202 Bitstream memory
203 Reference image input unit
204 Reference depth map input unit
205 View-synthesized image generating unit
206 View-synthesized image memory
207 View synthesis availability determining unit
208 Image decoding unit
209 View synthesizing unit
210 Occlusion map memory
211 Encoded information generating unit
212 Number-of-view-synthesis-available-regions decoding unit
213 View synthesis available region determining unit

1. An image encoding apparatus which performs encoding while predicting an image between different views using a reference image encoded for a view different from that of an encoding target image and a reference depth map for an object in the reference image when a multi-view image including images of a plurality of different views is encoded, the image encoding apparatus comprising:
a view-synthesized image generating unit which generates a view-synthesized image for the encoding target image using the reference image and the reference depth map;
an availability determining unit which determines whether the view-synthesized image is available for each of encoding target regions into which the encoding target image is divided; and
an image encoding unit which, for each of the encoding target regions, encodes nothing for each of the encoding target regions if the availability determining unit determines that the view-synthesized image is available and performs predictive encoding on the encoding target image for each of the encoding target regions while selecting a predicted image generation method if the availability determining unit determines that the view-synthesized image is unavailable.

2. An image encoding apparatus which performs encoding while predicting an image between different views using a reference image encoded for a view different from that of an encoding target image and a reference depth map for an object in the reference image when a multi-view image including images of a plurality of different views is encoded, the image encoding apparatus comprising:
a view-synthesized image generating unit which generates a view-synthesized image for the encoding target image using the reference image and the reference depth map;
an availability determining unit which determines whether the view-synthesized image is available for each of encoding target regions into which the encoding target image is divided; and
an image encoding unit which, for each of the encoding target regions, encodes a difference between the encoding target image and the view-synthesized image for each of the encoding target regions if the availability determining unit determines that the view-synthesized image is available and performs the predictive encoding on the encoding target image for each of the encoding target regions while selecting the predicted image generation method if the availability determining unit determines that the view-synthesized image is unavailable.

3. The image encoding apparatus according to claim 1, wherein, for each of the encoding target regions, the image encoding unit generates encoding information if the availability determining unit determines that the view-synthesized image is available.

4. The image encoding apparatus according to claim 3, wherein the image encoding unit determines a prediction block size as the encoding information.

5. The image encoding apparatus according to claim 3, wherein the image encoding unit determines a prediction method and generates encoding information for the prediction method.

6. The image encoding apparatus according to claim 1, wherein the availability determining unit determines whether the view-synthesized image is available based on quality of the view-synthesized image in each of the encoding target regions.

7. The image encoding apparatus according to claim 1, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

8. An image decoding apparatus which performs decoding while predicting an image between different views using a reference image decoded for a view different from that of a decoding target image and a reference depth map for an object in the reference image when the decoding target image is decoded from encoded data of a multi-view image including images of a plurality of different views, the image decoding apparatus comprising:
a view-synthesized image generating unit which generates a view-synthesized image for the decoding target image using the reference image and the reference depth map;
an availability determining unit which determines whether the view-synthesized image is available for each of decoding target regions into which the decoding target image is divided; and
an image decoding unit which, for each of the decoding target regions, sets the view-synthesized image for each of the decoding target regions as the decoding target image for each of the decoding target regions if the availability determining unit determines that the view-synthesized image is available and decodes the decoding target image for each of the decoding target regions from the encoded data while generating a predicted image if the availability determining unit determines that the view-synthesized image is unavailable.

9. An image decoding apparatus which performs decoding while predicting an image between different views using a reference image decoded for a view different from that of a decoding target image and a reference depth map for an object in the reference image when the decoding target image is decoded from encoded data of a multi-view image including images of a plurality of different views, the image decoding apparatus comprising:
a view-synthesized image generating unit which generates a view-synthesized image for the decoding target image using the reference image and the reference depth map;
an availability determining unit which determines whether the view-synthesized image is available for each of decoding target regions into which the decoding target image is divided; and
an image decoding unit which, for each of the decoding target regions, generates the decoding target image while decoding a difference between the decoding target image and the view-synthesized image from the encoded data if the availability determining unit determines that the view-synthesized image is available, and decodes the decoding target image for each of the decoding target regions from the encoded data while generating the predicted image if the availability determining unit determines that the view-synthesized image is unavailable.

10. The image decoding apparatus according to claim 8, wherein, for each of the decoding target regions, the image decoding unit generates encoding information if the availability determining unit determines that the view-synthesized image is available.

11. The image decoding apparatus according to claim 10, wherein the image decoding unit determines a prediction block size as the encoding information.

12. The image decoding apparatus according to claim 10, wherein the image decoding unit determines a prediction method and generates encoding information for the prediction method.

13. The image decoding apparatus according to claim 8, wherein the availability determining unit determines whether the view-synthesized image is available based on quality of the view-synthesized image in each of the decoding target regions.

14. The image decoding apparatus according to claim 8, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

15. An image encoding method for performing encoding while predicting an image between different views using a reference image encoded for a view different from that of an encoding target image and a reference depth map for an object in the reference image when a multi-view image including images of a plurality of different views is encoded, the image encoding method comprising:
a view-synthesized image generating step of generating a view-synthesized image for the encoding target image using the reference image and the reference depth map;
an availability determining step of determining whether the view-synthesized image is available for each of encoding target regions into which the encoding target image is divided; and
an image encoding step of, for each of the encoding target regions, encoding nothing for each of the encoding target regions if it is determined that the view-synthesized image is available in the availability determining step and performing predictive encoding on the encoding target image for each of the encoding target regions while selecting a predicted image generation method if it is determined that the view-synthesized image is unavailable in the availability determining step.

16. An image decoding method for performing decoding while predicting an image between different views using a reference image decoded for a view different from that of a decoding target image and a reference depth map for an object in the reference image when the decoding target image is decoded from encoded data of a multi-view image including images of a plurality of different views, the image decoding method comprising:
a view-synthesized image generating step of generating a view-synthesized image for the decoding target image using the reference image and the reference depth map;
an availability determining step of determining whether the view-synthesized image is available for each of decoding target regions into which the decoding target image is divided; and
an image decoding step of, for each of the decoding target regions, setting the view-synthesized image for each of the decoding target regions as the decoding target image for each of the decoding target regions if it is determined that the view-synthesized image is available in the availability determining step and decoding the decoding target image for each of the decoding target regions from the encoded data while generating a predicted image if it is determined that the view-synthesized image is unavailable in the availability determining step.

17. An image encoding program for causing a computer to execute the image encoding method according to claim 15.

18. An image decoding program for causing a computer to execute the image decoding method according to claim 16.

19. The image encoding apparatus according to claim 2, wherein, for each of the encoding target regions, the image encoding unit generates encoding information if the availability determining unit determines that the view-synthesized image is available.

20. The image encoding apparatus according to claim 19, wherein the image encoding unit determines a prediction block size as the encoding information.

21. The image encoding apparatus according to claim 19, wherein the image encoding unit determines a prediction method and generates encoding information for the prediction method.

22. The image encoding apparatus according to claim 2, wherein the availability determining unit determines whether the view-synthesized image is available based on quality of the view-synthesized image in each of the encoding target regions.

23. The image encoding apparatus according to claim 2, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

24. The image encoding apparatus according to claim 3, wherein the availability determining unit determines whether the view-synthesized image is available based on quality of the view-synthesized image in each of the encoding target regions.

25. The image encoding apparatus according to claim 3, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

26. The image encoding apparatus according to claim 4, wherein the availability determining unit determines whether the view-synthesized image is available based on quality of the view-synthesized image in each of the encoding target regions.

27. The image encoding apparatus according to claim 4, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

28. The image encoding apparatus according to claim 5, wherein the availability determining unit determines whether the view-synthesized image is available based on quality of the view-synthesized image in each of the encoding target regions.

29. The image encoding apparatus according to claim 5, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

30. The image encoding apparatus according to claim 19, wherein the availability determining unit determines whether the view-synthesized image is available based on quality of the view-synthesized image in each of the encoding target regions.

31. The image encoding apparatus according to claim 19, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

32. The image encoding apparatus according to claim 20, wherein the availability determining unit determines whether the view-synthesized image is available based on quality of the view-synthesized image in each of the encoding target regions.

33. The image encoding apparatus according to claim 20, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

34. The image encoding apparatus according to claim 21, wherein the availability determining unit determines whether the view-synthesized image is available based on quality of the view-synthesized image in each of the encoding target regions.

35. The image encoding apparatus according to claim 21, wherein the image encoding apparatus further comprises an occlusion map generating unit which generates an occlusion map representing pixels occluded on the reference image among pixels on the encoding target image using the reference depth map,
wherein the availability determining unit determines whether the view-synthesized image is available based on the number of the occluded pixels present within each of the encoding target regions using the occlusion map.

36. The image decoding apparatus according to claim 9, wherein, for each of the decoding target regions, the image decoding unit generates encoding information if the availability determining unit determines that the view-synthesized image is available.

37. The image decoding apparatus according to claim 36, wherein the image decoding unit determines a prediction block size as the encoding information.

38. The image decoding apparatus according to claim 36, wherein the image decoding unit determines a prediction method and generates encoding information for the prediction method.

39. The image decoding apparatus according to claim 9, wherein the availability determining unit determines whether the view-synthesized image is available based on quality of the view-synthesized image in each of the decoding target regions.

40. The image decoding apparatus according to claim 9, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

41. The image decoding apparatus according to claim 10, wherein the availability determining unit determines whether the view-synthesized image is available based on quality of the view-synthesized image in each of the decoding target regions.

42. The image decoding apparatus according to claim 10, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

43. The image decoding apparatus according to claim 11, wherein the availability determining unit determines whether the view-synthesized image is available based on quality of the view-synthesized image in each of the decoding target regions.

44. The image decoding apparatus according to claim 11, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

45. The image decoding apparatus according to claim 12, wherein the availability determining unit determines whether the view-synthesized image is available based on quality of the view-synthesized image in each of the decoding target regions.

46. The image decoding apparatus according to claim 12, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

47. The image decoding apparatus according to claim 36, wherein the availability determining unit determines whether the view-synthesized image is available based on quality of the view-synthesized image in each of the decoding target regions.

48. The image decoding apparatus according to claim 36, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

49. The image decoding apparatus according to claim 37, wherein the availability determining unit determines whether the view-synthesized image is available based on quality of the view-synthesized image in each of the decoding target regions.

50. The image decoding apparatus according to claim 37, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.

51. The image decoding apparatus according to claim 38, wherein the availability determining unit determines whether the view-synthesized image is available based on quality of the view-synthesized image in each of the decoding target regions.

52. The image decoding apparatus according to claim 38, wherein the image decoding apparatus further comprises an occlusion map generating unit which generates an occlusion map representing pixels occluded on the reference image among pixels on the decoding target image using the reference depth map,
wherein the availability determining unit determines whether the view-synthesized image is available based on the number of the occluded pixels present within each of the decoding target regions using the occlusion map.
